(19) United States
(12) Patent Application Publication
(10) Pub. No.: US 2019/0196415 A1
(43) Pub. Date: Jun. 27, 2019

(54) ELECTRONIC DEVICE AND CONTROL METHOD OF ELECTRONIC DEVICE

(71) Applicant: SEIKO EPSON CORPORATION, Tokyo (JP)

(72) Inventor: Kazumi MATSUMOTO, Shiojiri-shi (JP)

(73) Assignee: SEIKO EPSON CORPORATION, Tokyo (JP)

(21) Appl. No.: 16/220,471

(22) Filed: Dec. 14, 2018

(30) Foreign Application Priority Data
Dec. 27, 2017 (JP) 2017-250311

(51) Int. Cl. G04R 20/02; G04R 20/08; G01S 19/25

(52) U.S. Cl. CPC G04R 20/02; G01S 19/256; G04R 20/08

(57) ABSTRACT

A processor outputs selected frequency information from standard radio wave frequency information, GPS frequency information, LPWA frequency information, and mobile phone frequency information, and controls an oscillation circuit such that a frequency of a clock signal is close to a reference frequency. Accordingly, even in a case where an environment of an electronic device changes, it is possible to improve accuracy of an internal time by correcting a frequency of the clock signal by using a radio wave appropriate for the environment after the change.

### CROSS REFERENCE

This application claims priority to Japanese Patent Application No. 2017-250311, filed Dec. 27, 2017, the entire contents of which are expressly incorporated by reference herein.

### BACKGROUND

### 1. Technical Field

The present invention relates to an electronic device and a control method of an electronic device.

### 2. Related Art

In the related art, as a technique for adjusting an internal time of an electronic device to an accurate time, a configuration that receives a standard radio wave is known. For example, JP-A-2016-161467 discloses an electronic device that receives the standard radio wave. The electronic device demodulates the received standard radio wave to acquire a time code out (TCO) signal, extracts date information and time information from the TCO signal to correct the internal time to be adjusted to an accurate time.

A radio wave correction timepiece JP-A-2016-161467 includes: a receiver that receives a standard radio wave; a crystal oscillator 431 that generates a reference signal; a time counter 471 that measures an internal time based on the reference signal; a fixed time reception processor 472 that operates the receiver and executes reception processing; and a time correction unit 474 that corrects the internal time. The fixed time reception processor 472 executes the reception processing at a first time to acquire first reception time data, compares the acquired first reception time data with the internal time, and in a case where a time difference is equal to or greater than a first threshold value, executes the reception processing at a second time different from the first time to acquire second reception time data. However, even when the reception processing is executed at the first time or at the second time, in a case where the radio wave correction timepiece cannot receive the standard radio wave, there is a problem that the time cannot be corrected. Furthermore, even when the standard radio wave is received and the internal time is corrected, in a case where the frequency accuracy of a clock signal of the crystal oscillator 431 of the radio wave correction timepiece is low, there is a problem that an error in time due to the clock signal is accumulated in the internal time.

In addition, a case where the standard radio wave cannot be received corresponds to, for example, a case where a reception intensity of the standard radio wave temporarily deteriorates under the influence of noise or the like.

### SUMMARY

An advantage of some aspects of the invention is to improve accuracy of an internal time of an electronic device even in a case where an environment of the electronic device changes.

An electronic device according to a preferred aspect (first aspect) of the invention includes: a first receiver that receives a first radio wave and outputs first frequency information based on a carrier frequency of the first radio wave; a second receiver that receives a second radio wave and outputs second frequency information based on a carrier frequency of the second radio wave; an oscillation circuit that generates a clock signal used for measuring an internal time; a determination unit that determines a reception environment of the first radio wave and the second radio wave; a selection unit that outputs any of the first frequency information and the second frequency information as selected frequency information based on the determination result of the determination unit; and a correction unit that controls the oscillation circuit such that the frequency of the clock signal is close to a reference frequency determined in accordance with the selected frequency information.

According to the aspect, even in a case where the environment of the electronic device changes, the frequency of the clock signal is corrected by using the frequency information indicating the carrier frequency of the radio wave appropriate for the environment after the change from the first frequency information and the second frequency information, and thus, it becomes possible to improve the accuracy of the internal time.

In a preferred example (second aspect) of the first aspect, the first radio wave is a radio wave transmitted from a positional information satellite or a standard radio wave, and the determination unit determines whether the electronic device is positioned indoors or outdoors, and the selection unit selects the first frequency information in a case where the determination result of the determination unit is outdoors, and selects the second frequency information in a case where the determination result of the determination unit is indoors.

The radio wave transmitted from the positional information satellite and the carrier frequency of the standard radio wave are managed with high accuracy. Therefore, according to the aspect, when the electronic device is positioned outdoors, the frequency of the clock signal is controlled by using a carrier wave of the radio wave of which the frequency is managed with high accuracy, and thus, it is possible to further improve the accuracy of the internal time. Meanwhile, when the electronic device is positioned indoors, the frequency of the clock signal is corrected by using the second frequency information, and thus, it is possible to improve the accuracy of the internal time compared to a case where the frequency of the clock signal is not corrected.

In a preferred example (third aspect) of the second aspect, the determination unit determines whether the electronic device is positioned indoors or outdoors used on a reception intensity of the first radio wave received by the first receiver and a reception intensity of the second radio wave received by the second receiver.

In general, when the electronic device is positioned outdoors, the reception intensity of the radio wave transmitted from the positional information satellite and the standard radio wave increases. Therefore, according to the above-described aspect, it becomes possible to determine whether the electronic device is positioned outdoors or indoors with high accuracy.

In a preferred example (fourth aspect) of the first to third aspects, a power generation mechanist that generates electric power based on energy of light is further provided, and the determination unit determines whether the electronic device is positioned indoors or outdoors based on a comparison result between power generation amount per unit time generated by the power generation mechanism and a predetermined threshold value.

In general, when the electronic device is positioned outdoors, the power generation amount of the solar cell increases. Therefore, according to the above-described aspect, it becomes possible to determine whether the electronic device is positioned outdoors or indoors with high accuracy.

In a preferred example (fifth aspect) of the first to fourth aspect, an acceleration sensor is further provided, and the determination unit determines whether the electronic device is positioned indoors or outdoors based on a signal from the acceleration sensor.

For example, by integrating the acceleration measured by the acceleration sensor twice, it is possible to specify a moving distance of the electronic device. Therefore, according to the above-described aspect, by using an initial position, positional information indicating a position of a building, and the moving distance of the electronic device, it becomes possible to determine whether the electronic device is positioned outdoors or indoors with high accuracy.

In addition, in general, in a case where the electronic device is moving faster than a walking speed, a user holding the electronic device is on a car or a train, and thus, it is possible to assume that the electronic device 1 is outdoors. Therefore, according to the above-described aspect, by using the speed obtained by integrating the acceleration measured by the acceleration sensor, it becomes possible to determine whether the electronic device is positioned outdoors or indoors with high accuracy.

In a preferred example (sixth aspect) of the first to fifth aspects, the determination unit determines whether the electronic device is positioned indoors or outdoors based on whether or not the internal time within a predetermined time range.

According to the aspect, when a behavior pattern of the user of the electronic device is fixed, it becomes possible to determine whether the electronic device is positioned outdoors or indoors with high accuracy.

In a preferred example (seventh aspect) of the first to sixth aspects, the correction unit includes a moving speed specifying unit that outputs a control voltage for controlling the oscillation circuit, and specifies a moving speed of the electronic device, and the correction unit suppresses a control of the oscillation circuit such that the frequency of the clock signal is close to the reference frequency in a case where the moving speed specified by the moving speed specifying unit exceeds a predetermined threshold value.

In general, when the electronic device is moving at high speed, the carrier frequency of the radio wave changes due to the Doppler effect, and thus, there is a case where an error occurs in the carrier frequency. When the frequency of the clock signal is corrected by using the carrier frequency in which the error occurs, there is a concern that the accuracy of the internal time deteriorates. Therefore, according to the above-described aspect, in a case where the moving speed of the electronic device exceeds a predetermined threshold value, by suppressing the control of the oscillation circuit such that the frequency of the clock signal is close to the reference frequency without using the carrier frequency of the received radio wave, it becomes possible to suppress deterioration of the accuracy of the internal time.

In a preferred example (eighth aspect) of the first to seventh aspects, the second radio wave is a radio wave from a base station included in a mobile phone network.

In general, the carrier wave of the radio wave from the base station included in the mobile phone network is generated using an oven controlled Xtal oscillator. In the oven controlled Xtal oscillator, since the temperature of the crystal is kept constant by a thermostatic oven, it is possible to oscillate the frequency with higher accuracy than that of the temperature compensated Xtal oscillator generally included in the electronic device. Therefore, according to the above-described aspect, since the frequency of the clock signal is corrected by using the second frequency information based on the carrier frequency of the second radio wave in which the high accuracy is ensured by the oven controlled Xtal oscillator, it becomes possible to improve the accuracy of the internal time.

In a preferred example (ninth aspect) of the first to eighth aspects, the specifying unit that specifies a difference between the reference frequency and the frequency of the clock signal is included, and the correction unit controls the oscillation circuit based on the difference and corrects the frequency of the clock signal so as to be close to the reference frequency.

According to the aspect, by controlling the oscillation circuit such that the specified frequency difference is canceled, it becomes possible to make the frequency of the clock signal close to the reference frequency.

In a preferred example (tenth aspect) of the ninth aspect, the selected frequency information includes a signal of the carrier frequency of the received radio wave, the specifying unit performs a numerical arithmetic operation for converting a frequency with respect to the signal included in the selected frequency information, converts the signal into a reference wave of the reference frequency, and specifies a difference based on a first phase difference between the reference wave and the clock signal at a first time, a second phase difference between a reference wave and a clock signal at a second time, and a time period from the first time to the second time.

In general, as a method of obtaining a difference between two frequencies, there is a so-called counter method of counting the number of cycles of the other frequency within a time period obtained by multiplying one cycle of one frequency that serves as a reference by an integer and specifying the other frequency, and specifying the difference between one frequency and the other frequency. Therefore, in the counter system, in order to obtain information necessary for specifying the other frequency, it takes time that is an integral multiple of one cycle. Meanwhile, according to the aspect, it becomes possible to obtain the first phase difference and the second phase difference used for specifying the difference in the time period from the first time to the second time. By setting the time from the first time to the second time to the time until one cycle of the reference frequency elapses, it is possible to specify the difference in a shorter period of time compared to the counter method.

In a preferred example (eleventh aspect) of the ninth aspect, the selected frequency information includes a signal used for demodulating the received radio wave and a value obtained by subtracting the frequency of the signal from the carrier frequency of the received radio wave, the specifying unit performs the numerical arithmetic operation for converting the frequency to the reference frequency multiplied by a value obtained by subtracting the value from the carrier frequency of the received radio wave with respect to the signal included in the selected frequency information, converts the signal into the reference wave of the reference frequency, and specifies the difference based on the first phase difference between the reference wave and the clock signal at the first time, the second phase difference between the reference wave and the clock signal at the second time, and the time period from the first time to the second time.

There is a case where the selected frequency information includes the signal used for demodulating the received radio wave and the value obtained by subtracting the frequency of the signal from the frequency indicated by the selected frequency information. Even in this case, according to the above-described aspect, since it is possible to obtain the reference wave of the reference frequency, it is possible to specify the difference in a shorter period of time compared to the counter system.

In the a preferred example (twelfth aspect) of the ninth to eleventh aspects, the specifying unit includes an internal time correction unit that corrects the internal time based on the number of clock signals from the time when the internal time is set based on the radio wave transmitted from the positional information satellite or the standard radio wave to the current time, and the difference.

According to the aspect, in order to obtain a TCO signal, it is necessary to demodulate the standard radio wave, but in a case where the internal time is corrected by using the difference between the reference frequency and the frequency of the clock signal, the standard radio wave may not be demodulated. Similarly, in order to obtain time information from the radio wave transmitted from the positional information satellite, it is necessary to demodulate the radio wave transmitted from the positional information satellite, but in a case where the internal time is corrected by using the difference between the reference frequency and the frequency of the clock signal, the radio wave transmitted from the positional information satellite may not be demodulated. Therefore, by correcting the internal time by using the difference between the reference frequency and the frequency of the clock signal, compared to a case where the internal time is corrected by always using the TCO signal or the time information from the radio wave transmitted from the positional information satellite, it becomes possible to reduce the load on the correction of the internal time.

A control method of an electronic device according to a preferred aspect (thirteenth aspect) of the invention is a control method of an electronic device including a first receiver that receives a first radio wave and outputs first frequency information based on a carrier frequency of the first radio wave, a second receiver that receives a second radio wave and outputs second frequency information based on a carrier frequency of the second radio wave, and an oscillation circuit that generates a clock signal used for measuring an internal time, the method including causing the electronic device to determine a reception environment of the first radio wave and the second radio wave, output any of the first frequency information and the second frequency information as selected frequency information based on a determination result of determining the reception environment, and control the oscillation circuit such that the frequency of the clock signal is close to a reference frequency determined in accordance the selected frequency information.

According to the aspect, even in a case where the environment of the electronic device changes, the frequency of the clock signal is corrected by using the frequency information indicating the carrier frequency of the radio wave appropriate for the environment after the change from the first frequency information and the second frequency information, and thus, it becomes possible to improve the accuracy of the internal time.

In a preferred example (fourteenth aspect) of the thirteenth aspect, the first radio wave is a radio wave transmitted from a positional information satellite or a standard radio wave, and the electronic device determines whether the electronic device is positioned indoors or outdoors, and selects the first frequency information in a case where the determination result as to whether the electronic device is positioned indoors or outdoors is outdoors, and selects the second frequency information in a case where the determination result is indoors.

According to the aspect, the radio wave transmitted from the positional information satellite and the carrier frequency of the standard radio wave are managed with high accuracy. Therefore, according to the aspect, when the electronic device is positioned outdoors, the frequency of the clock signal is controlled by using the carrier wave of the radio wave of which the frequency is managed with high accuracy, and thus, it is possible to further improve the accuracy of the internal time. Meanwhile, when the electronic device is positioned indoors, the frequency of the clock signal is corrected by using the second frequency information, and thus, it becomes possible to improve the accuracy of the internal time compared to a case where the frequency of the clock signal is not corrected.

In a preferred example (fifteenth aspect) of the fourteenth aspect, the electronic device determines whether the electronic device is positioned indoors or outdoors based on a reception intensity of the first radio wave received by the first receiver and a reception intensity of the second radio wave received by the second receiver.

In general, when the electronic device is positioned outdoors, the reception intensity of the radio wave transmitted from the positional information satellite and the standard radio wave increases. Therefore, according to the above-described aspect, it becomes possible to determine whether the electronic device is positioned outdoors or indoors with high accuracy.

In a preferred example (sixteenth aspect) of the thirteenth tri fifteenth aspects, the electronic device determines whether the electronic device is positioned indoors or outdoors based on whether or not the internal time is within a predetermined time range.

According to the aspect, when a behavior pattern of the user of the electronic device is fixed, it becomes possible to determine whether the electronic device is positioned outdoors or indoors with high accuracy.

In a preferred example (seventeenth aspect) of the thirteenth to the sixteenth aspects, the electronic device outputs a control voltage for controlling the oscillation circuit, specifies a moving speed of the electronic device, and suppresses a control of the oscillation circuit such that the frequency of the clock signal is close to the reference frequency in a case where the specified moving speed exceeds a predetermined threshold value.

In general, when the electronic device is moving at high speed, the carrier frequency of the radio wave changes due to the Doppler effect, and thus, there is a case where an error occurs in the carrier frequency. When the frequency of the clock signal is corrected by using the carrier frequency in which the error occurs, there is a concern that the accuracy of the internal time deteriorates, Therefore, according to the above-described aspect, in a case where the moving speed of the electronic device exceeds a predetermined threshold value, by suppressing the control of the oscillation circuit such that the frequency of the clock signal is close to the reference frequency without using the carrier frequency of the received radio re, it becomes possible to suppress deterioration of the accuracy of the internal time.

In a preferred example (eighteenth aspect) of the thirteenth to the seventeenth aspects, the second radio wave is a radio wave from a base station included in a mobile phone network.

According to the aspect, in general, the carrier wave of the radio wave from the base station included in the mobile phone network is generated by using an oven controlled Xtal oscillator. In the oven controlled Xtal oscillator, since the temperature of the crystal is kept constant by a thermostatic oven, it is possible to oscillate the frequency with higher accuracy than that of the temperature compensated Xtal oscillator generally included in the electronic device. Therefore, according to the above-described aspect, since the frequency of the clock signal is corrected by using the second frequency information based on the carrier frequency of the second radio wave in which the high accuracy is ensured by the oven controlled Xtal oscillator, it becomes possible to improve the accuracy of the internal time.

In a preferred example (nineteenth aspect) of the thirteenth to the eighteenth aspects, the electronic device specifies a difference between the reference frequency and the frequency of the clock signal, and controls the oscillation circuit and corrects the frequency of the clock signal so as to be close to the reference frequency, based on the difference.

According to the aspect, by controlling the oscillation circuit such that the specified frequency difference is canceled, it becomes possible to make the frequency of the clock signal close to the reference frequency.

In a preferred example (twentieth aspect) of the nineteenth aspect, the selected frequency information includes a signal of a carrier frequency of the received radio wave, a numerical arithmetic operation for converting the frequency is executed with respect to the signal included in the selected frequency information and the signal is converted into a reference wave of the reference frequency, and a difference is specified based on a first phase difference between the reference wave and the clock signal at a first time, a second phase difference between the reference wave and the clock signal at a second time, and a time period, from the first time to the second time.

According to the aspect, it becomes possible to obtain the first phase difference and the second phase difference used for specifying the difference in the time period from the first to the second time. By setting the time period from the first time to the second time to the time period until one cycle of the reference frequency elapses, it is possible to specify the difference in a shorter period of time compared to the counter method.

### BRIEF DESCRIPTION OF THE DRAWINGS

The invention will be described with reference to the accompanying drawings, wherein like numbers reference like elements.

FIG. 1 is a perspective view of an electronic device according to a first embodiment.

FIG. 2 is a configuration view of the electronic device according to the first embodiment.

FIG. 3 is a view illustrating a relationship of Iₜ₁, Qₜ₁, Iₜ₂, and Qₜ₂.

FIG. 4 is a view illustrating a flowchart of a frequency correction processing.

FIG. 5 is a view illustrating a flowchart of a frequency information selection processing.

FIG. 6 is a configuration view of an electronic device according to a second embodiment.

FIG. 7 is a configuration view of an electronic device according to a third embodiment.

FIG. 8 is a configuration view of an electronic device according to a fourth embodiment.

FIG. 9 is a configuration view of an electronic device according to a fifth embodiment.

FIG. 10 is a configuration view of an electronic device according to a sixth embodiment.

### DESCRIPTION OF EXEMPLARY EMBODIMENTS

Hereinafter, aspects for carrying out the invention will be described with reference to the drawings. However, in each drawing, the dimensions and scales of each part are appropriately different from the actual dimensions and scales. In addition, since the embodiments described below are appropriate specific examples of the invention, various technically preferable limitations are given, but the scope of the invention is not limited to the aspects as long as it is not described that the invention is particularly limited in the following description.

### A. First Embodiment

Hereinafter, an electro do device 1 according to a first embodiment will be described.

### A.1. Outline of Electronic Device According to First Embodiment

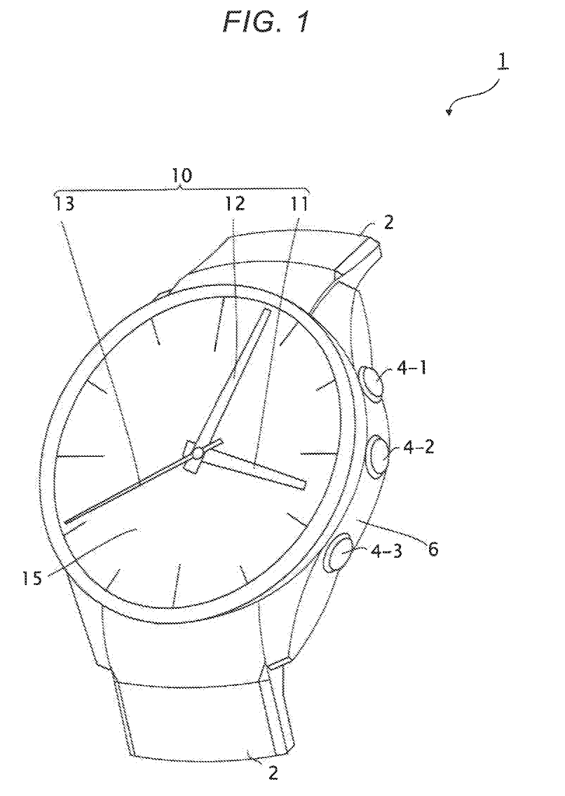

FIG. 1 illustrates a perspective view of the electronic device 1 in the first embodiment. The electronic device indicates the time by using a movement of electrons. As illustrated in FIG. 1, the electronic device 1 is a wristwatch. The electronic device 1 includes a band unit 2, a button 4-1, a button 4-2, a button 4-3, a case unit 6, a time display unit 10, and a solar cell 15 (example of “power generation mechanism”). The time display unit 10 includes an hour hand 11, a minute hand 12, and a second hand 13. The time display unit 10 indicates the time by the direction of each hand, such as the hour hand 11, the minute hand 12, and the second hand 13. The solar cell 15 generates power by converting energy of light into electric energy.

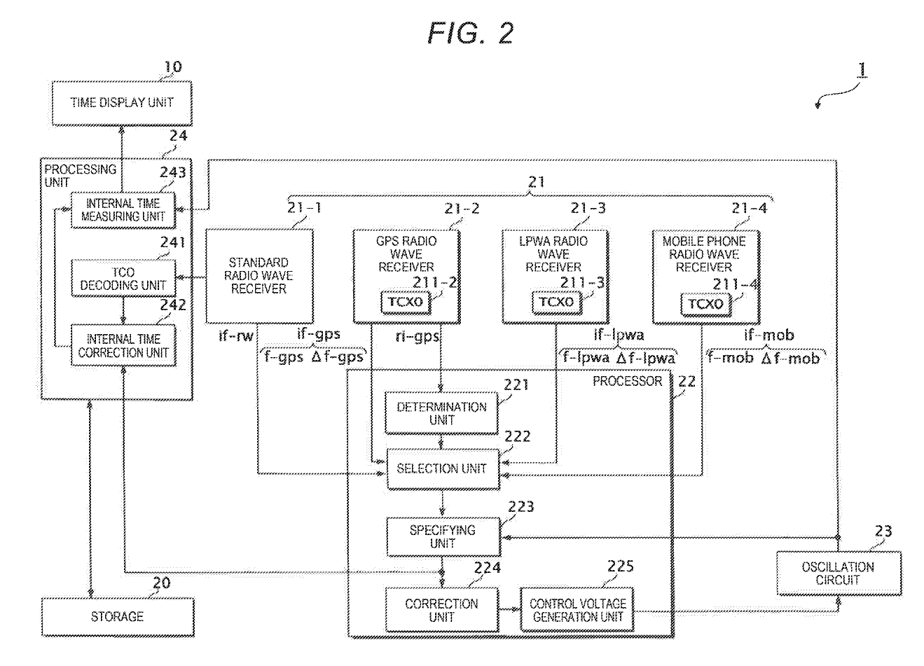

FIG. 2 illustrates a configuration view of the electronic device 1 in the first embodiment. The electronic device 1 includes a storage 20, a receiver 21, a processor 22, an oscillation circuit 23, a processing unit 24, and the time display unit 10. The processor 22 is an electronic circuit that executes processing designed by a designer, such as a field programmable gate array (FPGA) or an application specific IC (ASIC).

The storage 20 is a readable and writeable nonvolatile recording medium. The storage 20 is, for example, a flash memory. The storage 20 is not limited to the flash memory, and can be appropriately changed. The storage 20 stores, for example, a program to be executed by the processing unit 24.

The receiver 21 includes a standard radio wave receiver 21-1 (example of “first receiver” in the first embodiment), a global positioning system (GPS) radio wave receiver 21-2 (example of “first receiver”), a low power wide area (LPWA) radio wave receiver 21-3 (example of “second receiver”), and a mobile phone radio wave receiver 21-4 (example of “second receiver”).

The standard radio wave receiver 21-1 receives a standard radio wave (example of “first radio wave”). The standard radio wave is transmitted as a standard of a time and a frequency. There are a plurality of types of standard radio waves depending on the country to which the standard radio wave s transmitted, and examples thereof include JJY (registered trademark) transmitted in Japan, WWVB transmitted in the United States, DCF77 in Germany, MSF in the UK, BPC in China, and the like. In the following description, the standard radio wave is JJY and the frequency of the carrier wave of JJY is 40 kHz. The carrier wave of the standard radio wave is generated based on the national standard, such as a cesium atomic timepiece, and is a highly accurate signal with an error of ±10⁻¹².

### A.2. Time Setting by Standard Radio Wave

The standard radio wave receiver 21-1 outputs a TCO signal obtained by demodulating the received standard radio wave to the processing unit 24. The TCO signal is a signal obtained by demodulating the standard radio wave from the time when the second at the time of the national standard time is 0 seconds until one minute elapses.

The processing unit 24 is a computer, such as a central processing unit (CPU). The processing unit 24 controls the entire electronic device 1. The processing unit 24 realizes a TCO decoding unit 241, an internal time correction unit 242, and an internal time measuring unit 243 by reading and executing a program stored in the storage 20.

From the TCO si the TCO decoding unit 241 extracts a time code (time information) having date information, time information and the like included in the TCO signal. In addition, the TCO decoding unit 241 outputs the extracted time code to the internal time correction unit 242.

The internal time correction unit 242 outputs the time code obtained from the TCO decoding unit 241 to the internal time measuring unit 243 and sets the value based on the time code in the counter of the internal time measuring unit 243. Accordingly, the internal time is set.

The internal time measuring unit 243 measures the internal time by a signal having 1 Hz obtained by frequency-dividing a clock signal generated by the oscillation circuit 23. Specifically, the internal time measuring unit 243 includes a second counter for counting seconds, a minute counter for counting minutes, and an hour counter for counting hours. The internal time measuring unit 243 rotates the second hand 13 in a direction that corresponds to the value of the second counter, rotates the minute hand 12 in the direction that corresponds to the value of the minute counter, and rotates the hour hand 11 in the direction that corresponds to the value of the hour counter. Accordingly, the time display unit 10 displays the internal time.

The oscillation circuit 23 generates the clock signal used for measuring the internal time. The oscillation circuit 23 includes a crystal oscillator. The oscillation circuit 23 is, for example, a voltage controlled oscillator (VCO) that oscillates the clock signal of an oscillation frequency that corresponds to the control voltage. At the time of manufacturing, the oscillation circuit 23 is designed to oscillate the clock signal of a reference frequency f0 at which it is easy to measure one second. For measuring one second, the reference frequency f0 is preferably a frequency at which the frequency after the frequency-dividing by an exponentiation value of 2 becomes 1 Hz, and for example, 32.768 kHz is adopted. Hereinafter, the reference frequency f0 is assumed to b 32.768 kHz.

### A.3. Correction of Frequency of Clock Signal Based on Received Radio Wave and Clock Signal

In the first embodiment, the processor 22 selects any of the radio wave received by the standard radio wave receiver 21-1, the radio wave received by the GPS radio wave receiver 21-2, the radio wave received by the LPWA radio wave receiver 21-3, and the radio wave received by the mobile phone radiowave receiver 21-4, outputs the reference wave of the reference frequency f0 determined in accordance with the carrier frequency of the selected radio wave, and correct the frequency of the clock signal of the oscillation circuit 23 so as to be close to the reference wave. Hereinafter, a signal having a frequency of the reference frequency f0 is referred to as “reference wave”.

The standard radio wave receiver 21-1 receives the standard radio wave and transmits standard radio wave frequency information if-rw (example of “first frequency information”) to a selection unit 222 based on the frequency of the carrier wave of the received standard radio wave. The standard radio wave frequency information if-rw includes a carrier wave of the standard radio wave. As the carrier wave of the standard radio wave is included in the standard radio wave frequency information if-rw, the standard radio wave frequency information if-rw indicates the frequency of the carrier wave of the standard radio wave.

The GPS radio wave receiver 21-2 receives the radio wave transmitted from a GPS satellite which is one of the positional information satellites. Hereinafter, the radio wave transmitted from the GPS satellite is referred to as “GPS radio wave (example of “first radio wave”)”. The GPS radio wave receiver 21-2 demodulates the GPS radio wave and takes out a baseband signal. In order to demodulate the GPS radio wave, the GPS radio wave receiver 21-2 includes a temperature compensated Xtal oscillator (TCXO) 211-2. Therefore, a clock signal f-gps oscillated by the TCXO 211-2 is used for demodulating the GPS radio wave. A carrier wave of the GPS radio wave is generated based on a rubidium atomic timepiece or a cesium atomic timepiece, There are a plurality of frequencies of the carrier wave of the GPS radio wave, for example, 1575.42 MHz called an L1 band and 1227.6 MHz called an L2 band. Hereinafter, it is assumed that the carrier wave of the GPS radio wave is generated based on the rubidium atomic timepiece, and the frequency of the carrier wave of the GPS radio wave is 1575.42 MHz. Since the carrier wave of the GPS radio wave is generated based on the rubidium atomic timepiece, the carrier wave is a highly accurate signal with an error of 10⁻¹¹. Meanwhile, the frequency of the clock signal f-gps has a lower accuracy than that of the frequency of the carrier wave of the GPS radio wave and includes an error. The GPS radio wave receiver 21-2 takes out the baseband signal and specifies a carrier frequency difference Δf-gps (example of “value obtained by subtracting the frequency of the signal from the frequency indicated by the selected frequency information”) obtained by subtracting the frequency of the clock signal f-gps from the frequency of the carrier wave of the GPS radio wave.

The GPS radio wave receiver 21-2 receives the GPS radio wave from the GPS satellite and transmits GPS frequency information if-gps (example of “first frequency information”) to the selection unit 222 based on the carrier frequency of the GPS radio wave. The GPS frequency information if-gps includes a clock signal f-gps and a carrier frequency difference Δf-gps. The frequency obtained by adding the carrier frequency difference Δf-gps to the frequency of the clock signal f-gps matches the frequency of the carrier wave of the GPS radio wave. In the first embodiment, the GPS radio wave receiver 21-2 transmits a reception intensity ri-gps of the GPS radio wave to a determination unit 221.

The LPWA radio wave receiver 21-3 receives the radio wave used for a technique classified as LPWA. Hereinafter, the radio wave used for the technique classified as LPWA is referred to as “LPWA radio wave (example of “second radio wave”)” The LPWA indicates a standard for performing long distance communication with low power consumption. For example, the standard included in the LPWA is LoRaWAN, NB-IoT or the like. The LPWA radio wave receiver 21-3 demodulates the LPWA radio wave and takes out the baseband signal. In order to demodulate the LPWA radio wave, the LPWA radio wave receiver 21-3 includes a TCXO 211-3. The clock signal f-lpwa oscillated by the TCXO 211-3 is used for demodulating the LPWA radio wave. The LPWA radio wave is transmitted from a base station (hereinafter, referred to as “LPWA base station”) including an oven controlled Xtal oscillator (OCXO). In the OCXO, since the temperature of the crystal is kept constant by a thermostatic oven, it is possible to oscillate the frequency with high accuracy. The frequency of the carrier wave of the LPWA radio wave is a signal with an error of 0.2 to 0.6*10⁻⁶=0.2 to 0.6 ppm. Meanwhile, the clock signal f-lpwa has a lower accuracy than that of the frequency of the carrier wave of the LPWA radio wave and includes an error. The LPWA radio wave receiver 21-3 takes out the baseband signal and specifies the carrier frequency difference Δf-lpwa obtained by subtracting the frequency of the clock signal f-lpwa from the frequency of the carrier wave of the LPWA radio wave.

The LPWA radio wave receiver 21-3 receives the LPWA radio wave from the LPWA base station and transmits LPWA frequency information if-lpwa. (example of “second frequency information”) to the selection unit 222 based on the carrier frequency of the LPWA radio wave. The LPWA frequency information if-lpwa includes a clock signal f-lpwa and a carrier frequency difference Δf-lpwa. The frequency obtained by adding the carrier frequency difference Δf-lpwa to the frequency of the clock signal f-lpwa matches the frequency of the carrier wave of the LPWA radio wave. Furthermore, in the first embodiment, the LPWA frequency information if-lpwa has the reception intensity of the LPWA radio wave received by the LPWA radio wave receiver 21-3 for the use in the selection unit 222.

The mobile phone radio wave receiver 21-4 receives the radio wave from a base station (hereinafter, referred to as “mobile phone base station”) included in the mobile phone network. Hereinafter, the radio wave from the base station included in the mobile phone network is referred to as “mobile phone radio wave (example of “second radio wave”)”. The mobile phone radio wave receiver 21-4 demodulates the mobile phone radio wave and takes out the baseband signal, in order to demodulate the mobile phone radio wave, the mobile phone radio wave receiver 21-4 includes a TCXO 211-4. A clock signal f-mob oscillated by the TCXO 211-4 is used for demodulating the mobile phone radio wave. The mobile phone radio wave is transmitted based on the clock signal from the OCXO in the mobile phone base station, for example. Therefore, the accuracy of the frequency of the carrier wave of the mobile phone radio wave becomes approximately the same as that of the LPWA radio wave. Meanwhile, the clock signal f-mob has a lower accuracy than that of the frequency of the carrier wave of the mobile phone radio wave and includes an error. The mobile phone radio wave receiver 21-4 takes out the baseband signal and specifies a carrier frequency difference Δf-mob obtained by subtracting the frequency of the clock signal f-mob from the frequency of the carrier wave of the mobile phone radio wave.

The mobile phone radio wave receiver 21-4 receives the mobile phone radio wave from the mobile phone base station and transmits mobile phone frequency information if-mob (example of “second frequency information”) based on the frequency of the carrier wave of the mobile phone radio wave to the selection unit 222. The mobile phone frequency information if-mob includes the clock signal f-mob and the carrier frequency difference Δf-mob. The frequency obtained by adding the carrier frequency difference Δf-mob to the frequency of the clock signal f-mob matches the frequency of the carrier wave of the mobile phone radio wave. Furthermore, in the first embodiment, the mobile phone frequency information if-mob has the reception intensity of the mobile phone radio wave received by the mobile phone radio wave receiver 21-4 for the use in the selection unit 222.

A processor 22 selects frequency information from the standard radio wave frequency information if-rw, the GPS frequency information if-gps, the LPWA frequency information if-lpwa, and the mobile phone frequency information if-mob, and controls the oscillation circuit 23 such that the frequency of the clock signal is close to the reference frequency f0. The selected frequency information is referred to as “selected frequency information”. The reference frequency f0 is determined in accordance with the frequency indicated by the selected frequency information.

The frequency of each carrier wave of the standard radio wave, the GPS radio wave, the LPWA radio wave, the mobile phone radio wave has an extremely small error. Therefore, in a case where the frequency indicated by the selected frequency information is fc, the frequency obtained by converting the frequency indicated by the selected frequency information to f0/fc times can be regarded as the reference frequency f0. For example, the standard radio wave frequency information if-rw includes the carrier wave of the standard radio wave. When the frequency of the carrier wave of the standard radio wave is fc-rw and the frequency of the carrier wave of the standard radio wave is converted to f0/fc-rw times, a reference wave is obtained. In addition, the GPS frequency information if-gps includes the clock signal f-gps and the carrier frequency difference Δf-gps. Assuming that the frequency indicated by the GPS frequency information if-gps is fc-gps, the frequency of the clock signal f-gps becomes a value fc′-gps obtained by subtracting the carrier frequency difference Δf-gps from the frequency fc-gps, Therefore, when the clock signal f-gps is converted to f0/fc′-gps times, the frequency of the clock signal f-gps after the conversion becomes the reference frequency f0, and thus, a reference wave is obtained.

More specifically, a method of controlling the oscillation circuit 23 by the processor 22 will be described. The processor 22 includes the determination unit 221, the selection unit 222, a specifying unit 223, a correction unit 224, and a control voltage generation unit 225.

The determination unit 221 determines the reception environment of the standard radio wave, the GPS radio wave, the LPWA radio wave, and the mobile phone radio wave. For example, as the reception environment, the determination unit 221 determines whether the electronic device 1 is positioned indoors or outdoors. As a specific method of determining whether the electronic device 1 is positioned indoors or outdoors, for example, the determination unit 221 determines whether the electronic device 1 is positioned indoors or outdoors based on the reception intensity ri-gps of the GPS radio wave. For example, there are two methods as the determination method based on the reception intensity. In a first determination method based on the reception intensity, the determination unit 221 determines that the electronic device 1 is outdoors when the reception intensity ri-gps is equal to or greater than a predetermined threshold value. The reception intensity indicated in units of dBm, for example. In a second determination method based on the reception intensity, the determination unit 221 determines that the electronic device 1 is outdoors when an SN ratio obtained by subtracting a noise intensity from the reception intensity ri-gps is equal to or greater than the predetermined threshold value.

The selection unit 222 outputs any of the standard radio wave frequency information if-rw, the GPS frequency information if-gps, the LPWA frequency information if-lpwa, and the mobile phone frequency information if-mob as the selected frequency information based on the determination result of the determination unit 221. For example, in a case where the determination result of the determination unit 221 is outdoors, the selection unit 222 outputs the standard radio wave frequency information if-rw or the GPS frequency information if-g the selected frequency information, and in a case where the determination result of the determination unit 221 is indoors, the selection unit 222 outputs the frequency information other than the standard radio wave frequency information if-rw or the GPS frequency information as the selected frequency information.

In a case where the determination result of the determination unit 221 is outdoors, regarding which one of the standard radio wave frequency information if-rw and the GPS frequency information if-gps is selected by the selection unit 222, it is preferable to select the GPS frequency information if-gps due to two reasons below. A first reason is that, since the carrier wave of the standard radio wave is 40 kHz and the GPS radio wave is 1575.42 MHz, when obtaining a signal of one cycle of the carrier wave, the standard radio wave having a low frequency takes more time than the GPS radio wave. The second reason is that there is a case where a long wave to which the frequency of the carrier wave of the standard radio wave belongs is a frequency band having a lot of noise and the reception intensity of the standard radio wave decreases due to the noise. Therefore, in the following description, in a case where the determination result of the determination unit 221 is outdoors, the selection unit 222 selects the GPS frequency information if-gps.

In addition, in a case where the determination result of the determination unit 221 is indoors, the selection unit 222 outputs any of the standard radio wave frequency information if-rw, the LPWA frequency information if-lpwa, and the mobile phone frequency information if-mob as the selected frequency information. The reason for including the standard radio wave frequency information if-rw as a candidate for the selected frequency information is that, in general, the radio wave has a characteristic of being likely to be attenuated by obstacles as the frequency increases, and there is a case where the standard radio wave can be received even in a case where the electronic device 1 is positioned indoors and the GPS radio wave cannot be received.

As a method of selecting the selected frequency information in a case where the electronic device is indoors, the selection unit 222 outputs the selected frequency information based on the reception intensity of the standard radio wave, the reception intensity of the LPWA radio wave, and the reception intensity of the mobile phone radio wave. The reception intensity of the LPWA radio wave is included in the LPAW frequency information if-lpwa. In addition, the reception intensity of the mobile phone radio wave is included in the mobile phone frequency information if-mob.

For example, there are two methods as the selection method based on the reception intensity. In the first selection method based on the reception intensity, in a case where the determination result of the determination unit 221 is indoors, the selection unit 222 outputs the frequency information of the radio wave having the highest reception intensity as the selected frequency information among the standard radio wave frequency information if-rw, the LPWA frequency information if-lpwa, and the mobile phone frequency information if-mob. In the second selection method based on the reception intensity, in a case where the determination result of the determination unit 221 is indoors, the selection unit 222 outputs the frequency information of the radio wave having the highest SN ratio obtained by subtracting the noise intensity from the received intensity as the selected frequency information among the standard radio wave frequency information if-rw, the LPWA frequency information if-lpwa, and the mobile phone frequency information if-mob.

Hereinafter, the selection unit 222 will be described using a case where the selected frequency information is output by the first selection method based on the reception intensity.

The specifying unit 223 specifies a difference Δfv between the reference frequency f0 and a frequency f_{VCO} of the clock signal. Hereinafter, the difference between the reference frequency f0 and the frequency f_{VCO} of the clock signal is referred to as “frequency difference”. In order to specify the frequency difference Δfv, the specifying unit 223 performs a numerical arithmetic operation for converting the frequency into a signal included in the selected frequency information and converts the signal into the reference wave. The specifying unit 223 uses a numerical controlled oscillator (NCO) as an arithmetic unit that performs the numerical arithmetic operation for converting the frequency. The NCO can convert the signal into a signal having any frequency. Hereinafter, a case where the selected frequency information is the standard radio wave frequency information if-rw, and a case of the GPS frequency information if-gps, the LPWA frequency information if-lpwa, or the mobile phone frequency information if-mob, will be described separately.

In a case where the selected frequency information is the standard radio wave frequency information if-rw, the specifying unit 223 performs the arithmetic operation of the NCO with respect to the carrier wave of the standard radio wave included in the standard radio wave frequency information if-rw and converts the carrier wave into the reference wave. More specifically, when the frequency of the carrier wave of the standard radio wave is fc-rw, the specifying unit 223 performs the arithmetic operation of the NCO set to convert the frequency to f0/fc-rw times with respect to the frequency of the carrier wave of the standard radio wave, and converts the frequency to the reference wave.

In a case where the selected frequency information is the GPS frequency information if-gps, the LPWA frequency information if-lpwa, or the mobile phone frequency information if-mob, the selected frequency information includes the clock signal and the carrier frequency difference. The specifying unit 223 performs the arithmetic operation of the NCO set to convert the frequency to the reference frequency f0 times as much as the value obtained by subtracting the carrier frequency difference from the frequency indicated by the selected frequency information with respect to the signal included in the selected frequency information, and converts the signal to the reference wave.

For example, a case where the selected frequency information is the GPS frequency information if-gps will be described. The GPS frequency information if-gps includes the clock signal f-gps and the carrier frequency difference Δf-gps. Assuming that the frequency indicated by the GPS frequency information if-gps is fc-gps, the frequency of the clock signal f-gps is a value fc′-gps obtained by subtracting the difference Δf-gps from the frequency fc-gps. Therefore, the specifying unit 223 performs the arithmetic operation of the NCO set to convert the frequency to f0/fc′-gps times with respect to the clock signal f-gps, and converts the signal into the reference wave.

Next, the specifying unit 223 specifies the frequency difference Δfv based on the first phase difference between the reference wave and the clock signal at a time t1 (example of “first time”), the second phase difference between the reference wave and the clock signal at a time t2 (example of “second time”), and a time period PDI from the time t1 to the time t2. It is preferable that the time period PDI is less than one cycle of the reference frequency f0. Specifically, the specifying unit 223 combines the reference wave and the clock signal to each other, and generates a combined signal (referred to as an I signal) and a signal (referred to as a Q signal) obtained by delaying the I signal by a π/2 phase. Next, from the I signal and the Q signal, the specifying unit 223 specifies a value Iₜ₁ of the I signal and a value Qₜ₁ of the Q signal at the time t1 when the time period PDI has elapsed from a measurement start time, and a value Iₜ₂ of the I signal and a value Qₜ₂ of the Q signal at the time t2 when the time period PDI has further elapsed from the time t1.

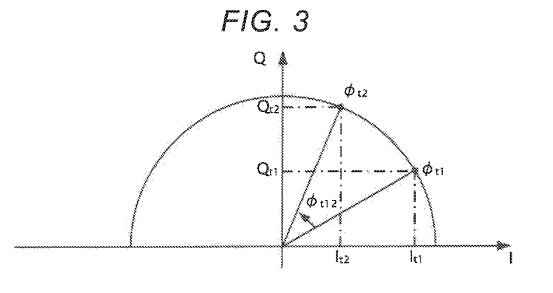

FIG. 3 illustrates a relationship of Iₜ₁, Qₜ₁, Iₜ₂, and Qₜ₂. As illustrated in FIG. 3, a phase difference between the reference wave and the clock signal is represented by a plural number in the I signal and the Q signal. The phase change amount Δϕₜ₁₂ of the second phase difference from the first phase difference is expressed by the following equation (1).

Δϕₜ₁₂=ϕₜ₂−ϕₜ₁ (1)

ϕₜ₁ is the first phase difference. ϕₜ₂ is the second phase difference. ϕₜ₁=Iₜ₁+jQₜ₁, and ϕₜ₂=Iₜ₂+jQₜ₂. j is an imaginary unit. From the trigonometry, the equation (1) is converted into the following equation (2) by using X=Cross/Dot.

Δϕₜ₁₂=tan⁻¹(X) (2)

Here, Cross=Iₜ₁*Qₜ₂−Iₜ₂*Qₜ₁, and Dot=Iₜ₁*Iₜ₂+Qₜ₁*Qₜ₂. Furthermore, Δϕₜ₁₂ is expressed by the following equation (3).

Δϕₜ₁₂+2nπ=2π*PDI*f_{VCO} (3)

n is an integer of 0 or more. Here, the time period PDI during which n=0 is 0<Δϕₜ₁₂<2π and is obtained as follows by using the expression (3).

0<Δϕₜ₁₂<2π⇔0<2π*PDI*f_{VCO}<2π⇔0<PDI<1/f_{VCO}

The frequency f_{VCO} the clock signal becomes a value close to the reference frequency f0. Therefore, the time period PDI is less than one cycle of the reference frequency f0, and it is possible to make substantially n=0. However, in a case where the frequency f_{VCO} of the clock signal becomes greater than the reference frequency f0, when the time period PDI is close to one cycle of the reference frequency f0, there is a concern that n is equal to or greater than 1. Therefore, it is preferable that the difference between Iₜ₁ and Iₜ₂ and the difference between Qₜ₁ and Qₜ₂ can be sufficiently measured and the time period PDI is sufficiently smaller than one cycle of the reference frequency f0. By setting that n=0 is possible, the arithmetic operation related to the specification of the frequency difference Δfv is simplified and the time taken for the arithmetic operation is shortened. When n=0, the frequency f_{VCO} of the clock signal is expressed by the following equation (4) by using the equations (2) and (3).

f_{VCO}=tan⁻¹(X)/(PDI*2π) (4)

In addition, from the frequency difference Δfv=the frequency f_{VCO} of the clock signal−the reference frequency f0, the specifying unit 223 specifies the frequency difference Δfv by using the expression (4).

The description returns to FIG. 2.

The correction unit 224 controls the oscillation circuit 23 and corrects the frequency f_{VCO} of the clock signal so as to be close to the reference frequency f0, based on the frequency difference Δfv. More specifically, the correction unit 224 corrects the frequency of the clock signal by controlling the oscillation circuit 23 such that the voltage based on the frequency difference Δfv is input to the oscillation circuit 23. For example, the correction unit 224 supplies data indicating the voltage at which the frequency difference Δfv is canceled to the control voltage generation unit 225. The control voltage generation unit 225 D/A converts the supplied data and outputs the control voltage indicated by the data to the oscillation circuit 23.

The voltage at which the frequency difference Δfv is canceled will be described more specifically. A case where the oscillation circuit 23 to which a voltage V0 is input at a first timing oscillates the clock signal of the reference frequency f0 and the specifying unit 223 specifies the frequency difference Δfv at a second timing, is assumed. In a case where the time period from the first timing to the second timing is long, the frequency of the clock signal changes due to the change with time of the oscillation circuit 23. In addition, even in a case where the temperature at the first timing is different from the temperature at the second timing, the frequency of the clock signal changes. In such a case, the correction unit 224 cancels the frequency difference Δfv at the second timing and notifies the control voltage generation unit 225 of the data in which the frequency of the clock signal is set as the reference frequency f0. For example, in a case where the magnitude of the control voltage that corresponds to the frequency difference Δfv is “−ΔV”, the control voltage generation unit 225 outputs the data indicating “V0−ΔV”.

The internal time correction unit 242 corrects the internal time based on the frequency difference Δfv and the number of clock signals from the time when the internal time is set based on the time information of the standard radio wave to the current time. A specific correction method will be described. At the first timing, it is assumed that the standard radio wave receiver 21-1 receives the standard radio wave, the TCO decoding unit 241 extracts the time code from the TCO signal obtained by demodulating the standard radio wave, and the internal time correction unit 242 sets the internal time in accordance with the time code. Furthermore, at the first timing, it is assumed that the specifying unit 223 specifies a frequency difference Δfv0 based on the selected frequency information and the correction unit 224 makes the frequency f_{VCO} of the clock signal match the reference frequency f0 based on the frequency difference Δfv0. In addition, at the second timing after the first timing, it is assumed that the specifying unit 223 has specified the frequency difference Δfv based on the selected frequency information. There is a case where the selected frequency information at the first timing and the selected frequency information at the second timing are the frequency information of the same type of the radio wave or a case where the selected frequency information at the first timing and the selected frequency information at the second timing are different types of the frequency information radio waves.

In a case of receiving the frequency difference Δfv, the internal time correction unit. 242 adds the number of clock signals*(1/(f0Δfv)−1/f0) from the time when the internal time is set at the first timing to the current time, to the present internal time. (1/(f0+Δfv)−1/f0) indicates an error from an accurate time generated as one clock elapses. For example, in a case where the Δfv is a positive value, the time period of one clock after the first timing becomes short and the internal time is advanced from the accurate time. In addition, since 1/(f0+Δfv)−1/f0 becomes a negative value, the internal time correction unit 242 reduces the value of the internal time, and thus, the internal time can close to the accurate time.

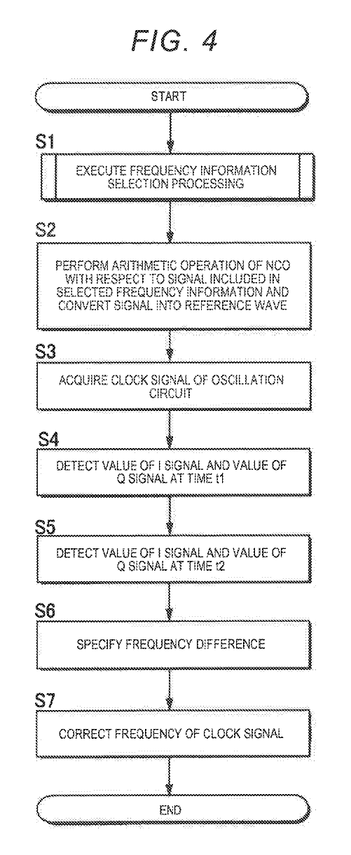

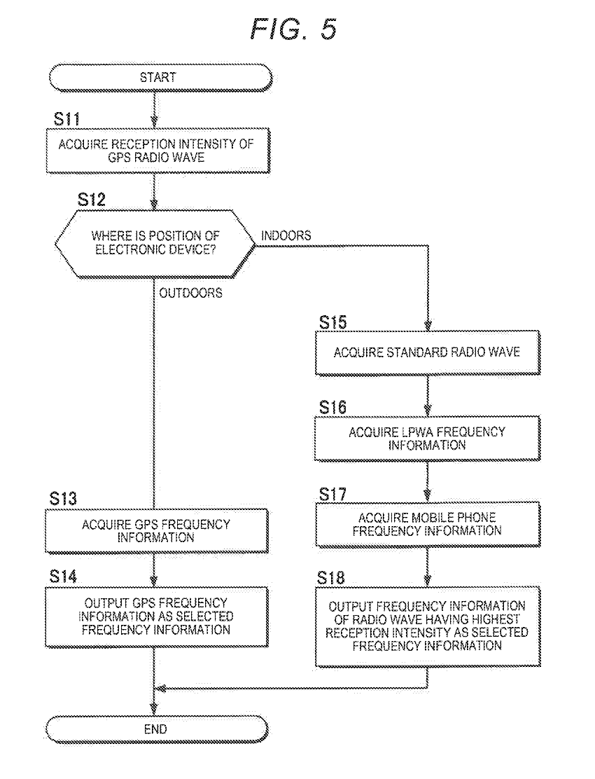

FIG. 4 is a view illustrating a flowchart of a frequency correction processing. The determination unit 221 and the selection unit 222 cooperatively execute frequency information selection processing (step S1), The frequency information selection processing will be described with reference to FIG. 5.

FIG. 5 is a view illustrating a flowchart of the frequency information selection processing. The determination unit 221 acquires the reception intensity ri-gps of the GPS radio wave from the GPS radio wave receiver 21-2 step S11). The determination unit 221 determines whether the electronic device 1 is positioned outdoors or indoors based on the reception intensity ri-gps (step S12).

In a case where it is determined that the electronic device 1 is positioned outdoors (step S12: outdoors), the selection unit 222 acquires the GPS frequency information if-gps (step S13) and outputs the GPS frequency information if-gps as the selected frequency information (step S14). In a case where it is determined that the electronic device 1 is positioned indoors (step S12: indoors), the selection unit 222 acquires the standard radio wave frequency information if-rw from the standard radio wave receiver 21-1 (step S15). In addition, the selection unit 222 acquires the LPWA frequency information if-lpwa from the LPWA radio wave receiver 21-3 (step S16). In addition, the selection unit 222 acquires the mobile phone frequency information if-mob from the mobile phone radio wave receiver 21-4 (step S17). The selection unit 222 refers to the acquired standard radio wave frequency information if-rw, the LPWA frequency information if-lpwa, and the mobile phone frequency information if-mob, and outputs the frequency information of the radio wave having the highest reception intensity as the selected frequency information (step S18). After the processing of step S14 or step S18 is ended, the determination unit 221 and the selection unit 222 end a series of processing illustrated in FIG. 5.

The description returns to FIG. 4.

The specifying unit 223 performs the arithmetic operation of the NCO with respect to the signal included in the selected frequency information and converts the signal into the reference wave (step S2).

Next, the specifying unit 223 acquires the clock signal of the oscillation circuit 23 (step S3). In addition, the specifying unit 223 detects the value Iₜ₁ of the I signal and the value Qₜ₁ of the Q signal at the time t1 from the I signal and the Q signal obtained by combining the reference wave and the clock signal with each other (step S4). Subsequently, the specifying unit 223 detects the value Iₜ₂ of the I signal and the value Qₜ₂ of the Q signal at time t2 (step S5). In addition, the specifying unit 223 specifies the frequency difference Δfv by using the expression (4) based on Iₜ₁, Qₜ₁, Iₜ₂, Qₜ₂, and the time period PDI (step S6).

The correction unit 224 corrects the frequency f_{VCO} of the clock signal based on the frequency difference Δfv (step S7) After the processing of step S7 is ended, the electronic device 1 ends the series of processing.

### A.4. Effect of First Embodiment

As described above, the processor 22 controls the oscillation circuit 23 such that the frequency of the clock signal is close to the reference frequency f0 determined in accordance with the selected frequency information. Accordingly, even in a case where the environment of the electronic device 1 changes, the internal time can continue to indicate the accurate time by always correcting the frequency f_{VCO} of the clock signal using the frequency information of the radio wave appropriate for the environment after the change. For example, when the electronic device 1 moves to be positioned on the inside of the reinforced concrete building in a case where the frequency f_{VCO} of the clock signal is corrected by using the standard radio wave in the environment before the change, since the radio wave is blocked by the steel material in the reinforced concrete, it becomes difficult to receive the standard radio wave, the GPS radio wave, and the mobile one radio wave transmitted from the outside of the building. However, the LPWA radio wave transmitted from the inside of the building becomes the radio wave appropriate for the environment after the change and can be received. Therefore, the processor 22 can improve the accuracy of the internal time by outputting the LPWA frequency information if-lpwa of the LPWA radio wave transmitted from the inside of the building as the selected frequency information. When it is possible to maintain the frequency difference Δfv/reference frequency f0 to be ±0.03 ppm by correcting the frequency f_{VCO} of the clock signal, it becomes possible to realize an annual difference of ±1 second.

Further, the specifying unit 223 specifies the frequency difference Δfv between the reference frequency f0 and the frequency of the clock signal, and the correction unit 224 controls the oscillation circuit 23 based on the frequency difference Δfv specified by the specifying unit 223 and corrects the frequency f_{VCO} of the clock signal so as to be close to the reference frequency f0. By controlling the oscillation circuit 23 such that the specified frequency difference Δfv is canceled, the correction unit 224 can make the frequency f_{VCO} of the clock signal close to the reference frequency f0.

Further, the specifying unit 223 specifies the frequency difference Δfv based on the first phase difference, the second phase difference, and the time period PDI. In the method of specifying the frequency difference Δfv based on the phase difference, it becomes possible to specify the frequency difference Δfv/reference frequency f0 with accuracy of ±10⁻⁷ in a short period of time of several tens of milliseconds to several seconds or less.

A case where the method of specifying the frequency difference Δfv based on the phase difference is performed in a short period of time will be described. In the method of specifying the frequency difference Δfv based on the phase difference, in order to obtain X in the above-described equation (2), the time from the measurement start time to the time t2 elapses, and thus, a time period of the time period PDI*2 becomes necessary. Since the time period PDI becomes approximately 1/reference frequency f0 at the longest, the time period PDI*2=2/(32.768*10³)=approximately 0.06 msec. As described above, it becomes possible to perform the method of specifying the frequency difference Δfv based on the phase difference in a short period of time of several tens of milliseconds to several seconds or less even when the time period PDI*2 is approximately 0.06 msec at the longest and the time required for the arithmetic operation of the expression (4) is added.

Meanwhile, as a method of obtaining a difference between two frequencies, there is a so-called counter method of counting the number of cycles of the other frequency within a time period obtained by multiplying one cycle of one frequency that serves as a reference by n (n is a natural number) and specifying the other frequency, and specifying the difference between one frequency and the other frequency. However, in the count method, when it is attempted to specify the frequency difference Δfv/reference frequency f0 with accuracy of ppm, a relatively long period of time is required. More specifically, the accuracy obtained by the counter system depends on the number of clocks of the other frequency within a fixed time period. Therefore, in order to increase the accuracy with the counter method, it becomes necessary to increase n in order to increase the number of clocks of the other frequency, and thus, the counter method is not practical at a low frequency, such as 32.768 kHz. In this manner, the method of specifying the frequency difference Δfv based on the phase difference can be performed in a shorter period of time than that in the counter method.

Since it becomes possible to specify the frequency difference Δfv in a short period of time, it becomes easy to correct the internal time in a short period of time.

Further, the processor 22 determines whether the electronic device 1 is positioned indoors or outdoors, and in a case where the determination result is outdoors, the processor 22 outputs the GPS frequency information if-gps as the selected frequency information, and in a case where the determination result is indoors, the processor 22 outputs any of the standard radio wave frequency information if-rw, the LPWA frequency information if-lpwa, and the mobile phone frequency information if-mob as the selected frequency information. Since the GPS radio wave and the standard radio wave are managed with higher accuracy than the LPWA radio wave and the mobile phone radio wave, it is possible to correct the internal time with higher accuracy by using the GPS radio wave or the standard radio wave. When comparing the GPS radio wave and the standard radio wave with each other, as described above, when obtaining a signal of one cycle of the carrier wave, the standard radio wave having a low frequency takes longer time than the GPS radio wave. In addition, there is a case where a long wave to which the frequency of the carrier wave of the standard radio wave belongs is frequency band with a lot of noise and the reception intensity of the standard radio wave decreases due to the noise. From the above-described result, it is preferable to select the GPS frequency information if-gps as the selected frequency information. However, in general, the radio wave is likely to be attenuated by obstacles as the frequency becomes higher. Therefore, in a case where the electronic device 1 is positioned indoors or underground, the GPS radio wave is more unlikely to reach the electronic device 1 compared to the standard radio wave.

Therefore, when the electronic device is positioned outdoors, the processor 22 corrects the internal time with high accuracy by using the GPS radio wave. In addition, even when the electronic device 1 is positioned indoors, the internal time is corrected by using any of the standard radio wave, the LPWA radio wave, and the mobile phone radio wave. In this manner, even in a case where the environment of the electronic device 1 changes, it is possible to correct the internal time with high accuracy.

The processor 22 can select the LPWA frequency if-lpwa as the selected frequency information. A carrier wave of the LPWA radio wave is generated by using the OCXO. The OCXO can oscillate the frequency with higher accuracy than the TCXO 211-3. Therefore, in a case of selecting the LPWA frequency information if-lpwa as the selected frequency information, the frequency of the clock signal is corrected by using the carrier wave of the LPWA radio wave of which the high accuracy is maintained by the OCXO, and thus, it is possible to improve the accuracy of the internal time. In addition, even in a case where the electronic device 1 is positioned in a place where the GPS radio wave and the standard radio wave cannot be received, there is a case where it is possible to receive the LPWA radio wave, and it is possible to correct the internal time with high accuracy by using the carrier wave of the received LPWA radio wave.

The processor 22 can select mobile phone frequency information if-mob as the selected frequency information. The carrier wave of the mobile phone radio wave is generated by using the OCXO in the mobile phone base station. Therefore, since the frequency of the clock signal is corrected by using the carrier wave of the mobile phone radio wave which the high accuracy is maintained by the OCXO, it possible to improve the accuracy of the internal time.

The internal time correction unit 242 corrects the internal time based on the frequency difference Δfv and the number of clock signals from the time when the internal time is set based on the standard radio wave to the current time. Accordingly, the electronic device 1 can complete the correction of the internal time in a shorter period of time compared to a case of setting the internal time by always using the TCO signal in a case where the standard radio wave is received. Specifically, in order to obtain the TCO signal, it is necessary to demodulate the standard radio wave, but in a case where the internal time is corrected by using the frequency difference Δfv, the standard radio wave may not be demodulated. Therefore, by correcting the internal time by using the frequency difference Δfv, compared to a case where the internal time is corrected by always using the TOO signal, it becomes possible to reduce the load on the correction of the internal time.

In addition, in a case of setting the internal time using the TOO signal, in JJY, as described above, since the TOO signal is transmitted over 1 minute, it takes at least 1 minute to set the internal time. In contrast, in a case of correcting the internal time by using the frequency difference Δfv, the frequency difference Δfv can be specified within a short period of time of several tens of milliseconds to several seconds or less.

### B. Second Embodiment

In the first embodiment, the determination unit 221 determines that the electronic device 1 is outdoors in a case where it is determined that the GPS radio wave receiver 21-2 can receive the GPS radio wave. In a second embodiment, based on the reception intensity of the GPS radio wave and the reception intensity of the radio wave of any of the standard radio wave, the LPWA radio wave, and the mobile phone radio wave, it is determined whether the electronic device 1 is positioned outdoors or indoors Hereinafter, the second embodiment will be described. In addition, in each aspect and each modification example described below, elements having the same operations or functions as those in the first embodiment will be given the same reference numerals as those used in the first embodiment, and the detailed description thereof will be appropriately omitted.

### B.1. Outline of Electronic Device 1 According to Second Embodiment

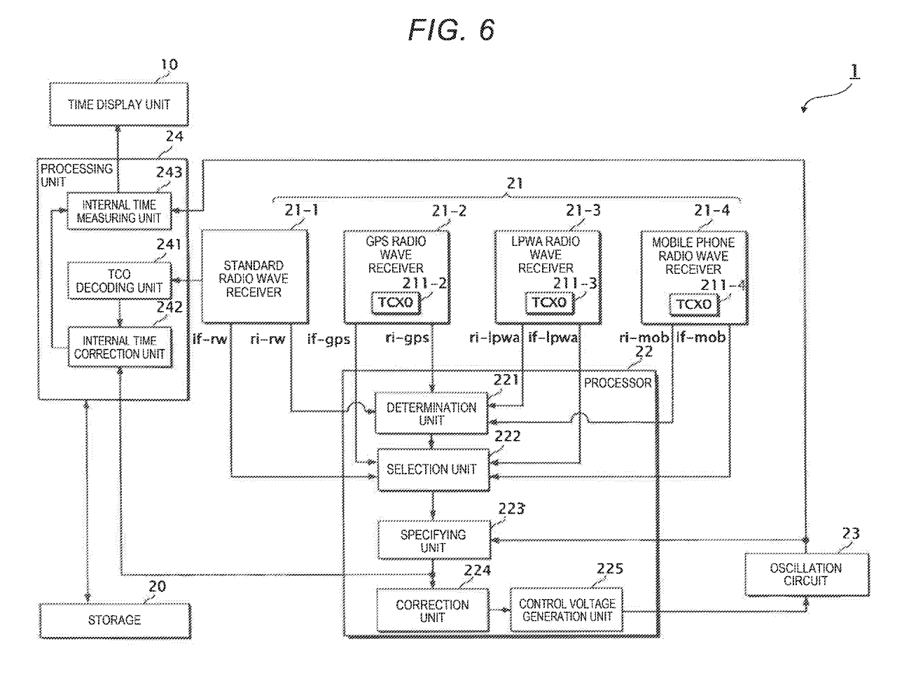

FIG. 6 illustrates a configuration view of the electronic device 1 in the second embodiment. In the second embodiment, the standard radio wave receiver 21-1 outputs a reception intensity ri-rw of the standard radio wave to the determination unit 221. In addition, the LPWA radio wave receiver 21-3 outputs a reception intensity ri-lpwa of the LPWA radio wave to the determination unit 221. Similarly, the mobile phone radio wave receiver 21-4 outputs a reception intensity ri-mob of the mobile phone to the determination unit 221.

Based on any of the reception intensity ri-gps of the GPS radio wave, the reception intensity ri-rw of the standard radio wave, the reception intensity ri-lpwa of the LPWA radio wave, and the reception intensity ri-mob of the mobile phone radio wave, the determination unit 221 determines whether the electronic device 1 Is positioned outdoors or indoors. For example, there are two methods as the determination method based on the reception intensity. In the first determination method based on the reception intensity, the determination unit 221 determines that the electronic device 1 is positioned outdoors when the reception intensity ri-gps is greater than the reception intensity of the radio wave other than the GPS radio wave. In the second determination method based on the reception intensity, the determination unit 221 determines that the electronic device 1 is positioned outdoors when the SN ratio obtained by subtracting the noise intensity from the reception intensity ri-gps is greater than the SN ratio obtained by subtracting the noise intensity from the reception intensity of the radio wave other than the GPS radio wave.

Regarding using the reception intensity of the radio wave of any of the reception intensity ri-rw, the reception intensity ri-lpwa, and the reception intensity ri-mob, for example, the determination unit 221 uses the reception intensity of the radio wave having the highest radio wave intensity among the standard radio wave, the LPWA radio wave, and the mobile phone radio wave.

### B.2. Effect of Second Embodiment

As described above, based on any of the reception intensity ri-gps, the reception intensity ri-rw, the reception intensity ri-lpwa, and the reception intensity ri-mob, the determination unit 221 determines whether the electronic device 1 is positioned outdoors or indoors. When the electronic device 1 is positioned outdoors, the reception intensity ri-gps becomes high, and thus, it becomes possible to determine whether the electronic device 1 is positioned outdoors or indoors with high accuracy.

### C. Third Embodiment

In the second embodiment, based on any of the reception intensity ri-gps, the reception intensity ri-rw, the reception intensity ri-lpwa, and the reception intensity ri-mob, the determination unit 221 determined whether the electronic device 1 was positioned outdoors or indoors. In a third embodiment, based on a power generation amount per unit time generated by the solar cell 15, it is determined whether the electronic device 1 is positioned outdoors or indoors. Hereinafter, the third embodiment will be described. In addition, in each aspect and each modification example described below, elements having the same operations or functions as those in the first embodiment or the second embodiment will be given the same reference numerals as those used in the first embodiment or the second embodiment, and the detailed description thereof will be appropriately omitted.

### C.1. Outline of Electronic Device 1 According to Third Embodiment

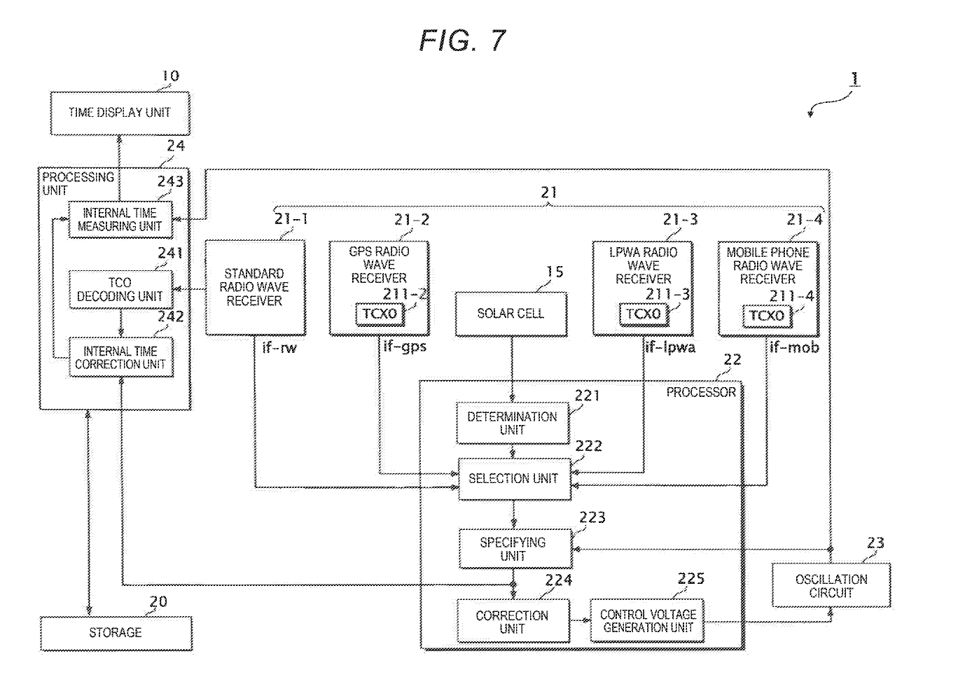

FIG. 7 illustrates a configuration view of the electronic device 1 in the third embodiment. In the third embodiment, the solar cell 15 outputs the power generation amount per unit time to the determination unit 221.

Based on the comparison result of the power generation amount per unit time generated by the solar cell 15 and the predetermined threshold value, the determination unit 221 determines whether the electronic device 1 is positioned outdoors or indoors. For example, when the power generation amount per unit time generated by the solar cell 15 is greater than the predetermined threshold value, the determination unit 221 determines that the electronic device 1 is positioned outdoors, and when the power generation amount per unit time generated by the solar cell 15 is equal to or less than the predetermined threshold value, the determination unit 221 determines that the electronic device 1 is positioned indoors.

### C.2. Effect of Third Embodiment

As described above, based on the power generation amount per unit time generated by the solar cell 15, the determination unit 221 determines whether the electronic device 1 is positioned outdoors or indoors. In general, when the electronic device 1 is positioned outdoors, the power generation amount of the solar cell 15 increases. The power generation amount of the solar cell 15 when the weather is cloudy or rainy is less than that in a case where the weather is sunny, but the power generation amount is generally greater than that in a case where the electronic device 1 is positioned indoors. Therefore, by using the power generation amount per unit time of the solar cell 15, it becomes possible to determine whether the electronic device 1 is positioned outdoors or indoors with high accuracy.

### D. Fourth Embodiment

In the third embodiment, based on the power generation amount per unit time generated by the solar cell 15, it was determined whether the electronic device 1 was positioned outdoors or indoors. In a fourth embodiment, based on the acceleration measured by an acceleration sensor 25, it is determined whether the electronic device 1 is positioned outdoors or indoors. Hereinafter, the fourth embodiment will be described. In addition, in each aspect and each modification example described below, elements having the same operations or functions as those in the first embodiment, the second embodiment, or the third embodiment will be given the same reference numerals as those used in the first embodiment, the second embodiment, or the third embodiment, and the detailed description thereof will be appropriately omitted.

### D.1. Outline of Electronic Device 1 According to Fourth Embodiment

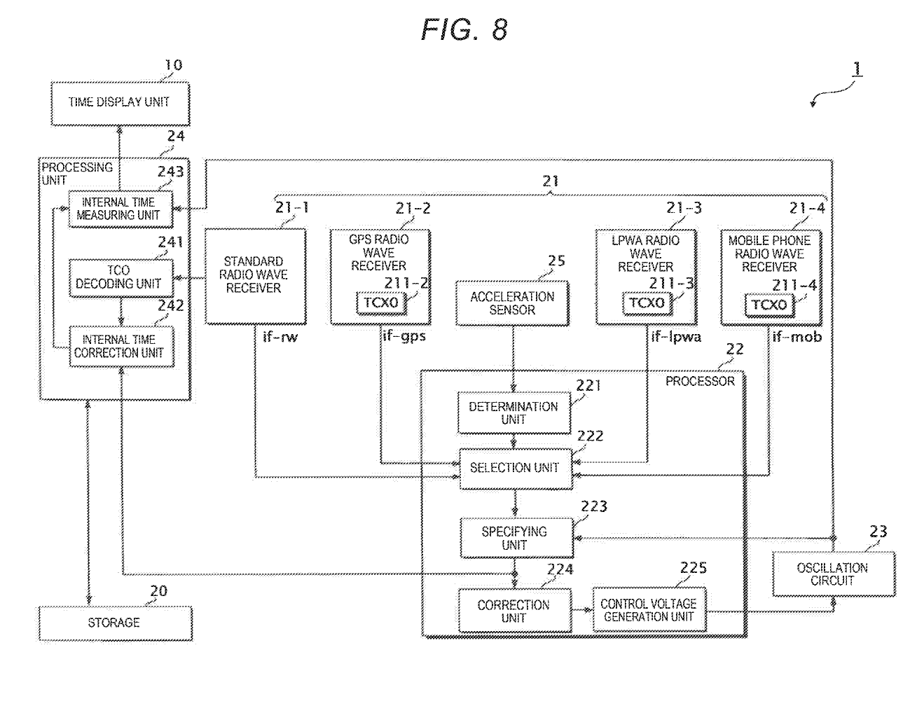

FIG. 8 illustrates a configuration view of the electronic device 1 in the fourth embodiment. In the fourth embodiment, the electronic device 1 includes the acceleration sensor 25. The acceleration sensor 25 measures the acceleration of the electronic device 1. The acceleration sensor 25 outputs the signal including the measured acceleration to the determination unit 221.

Based on the signal from the acceleration sensor 25, the determination unit 221 determines whether the electronic device 1 is positioned outdoors or indoors. For example, there are three determination methods for determining whether the electronic device 1 is outdoors or indoors based on the acceleration.

In the first determination method of determining whether the electronic device 1 is outdoors or indoors based on the acceleration, the position of the electronic device 1 is specified by the moving distance of the electronic device 1 obtained by the acceleration, and it is determined whether the electronic device 1 is positioned outdoors or indoors based on the specified position. For example, the storage 20 stores the positional information indicating the position of the building. In addition, the determination unit 221 stores the position specified from the GPS radio wave or the position specified from the mobile phone radio wave in the storage 20 as the initial position of the electronic device 1. The determination unit 221 refers to the positional information and determines whether the electronic device 1 is positioned outdoors or outdoors by determining whether the current position obtained by adding the moving distance obtained by integrating the acceleration measured by the acceleration sensor 25 twice from the initial position of the electronic device 1 is on the inside or the outside of the building.

In the second determination method of determining whether the electronic device 1 is outdoors or indoors based on the acceleration, in a case where the electronic device 1 moves faster than the walking speed, it is considered that the user having the electronic device 1 is on a car or a train and the electronic device 1 is outdoors. Here, the determination unit 221 determines that the electronic device 1 is positioned outdoors when the speed obtained by integrating the acceleration measured by the acceleration sensor 25 is higher than the general walking speed as a predetermined threshold value.

In a third determination method of determining whether the electronic device 1 is outdoors or indoors based on the acceleration, even in a case where the electronic device 1 is positioned indoors, and in a case where the user having the electronic device 1 is in an elevator of the building, there is a possibility of moving faster than the walking speed. Here, it is assumed that the acceleration sensor 25 can detect the acceleration in three axial directions. In a case where the speed obtained by integrating the speed in the vertical direction measured by the acceleration sensor 25 is higher than the predetermined threshold value, the determination unit 221 determines that the electronic device 1 is positioned indoors. In addition, in a case where the electronic device 1 rotates, the electronic device 1 includes a gyro sensor that can measure the angular velocity of three axes, specifies the inclination of the electronic device 1, and specifies the vertical direction from the specified inclination.

### D.2. Effect of Fourth Embodiment

As described above, based on the measured acceleration, the determination unit 221 determines whether the electronic is device 1 is positioned outdoors or indoors described above, by using the measured acceleration, it becomes possible to determine whether the electronic device 1 is positioned outdoors or indoors with high accuracy.

### E. Fifth Embodiment

In the fourth embodiment, based on the acceleration measured by an acceleration sensor 25, it was determined whether the electronic device 1 was positioned outdoors or indoors. In a fifth embodiment, based on the internal time, it is determined whether the electronic device 1 is positioned outdoors or indoors. Hereinafter, the fifth embodiment will be described. In addition, in each aspect and each modification example described below, elements having the same operations or functions as those in the first embodiment, the second embodiment, the third embodiment, or the fourth embodiment will be given the same reference numerals as those used in the first embodiment, the second embodiment, the third embodiment, or the fourth embodiment, and the detailed description thereof will be appropriately omitted.

### E.1. Outline of Electronic Device 1 According to Fifth Embodiment

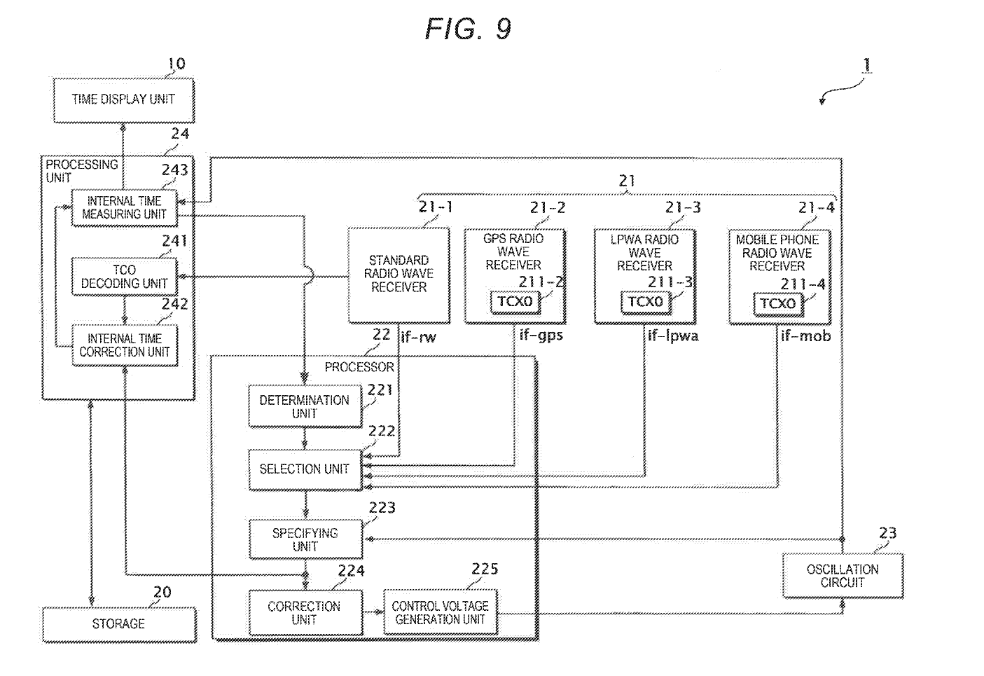

FIG. 9 illustrates a configuration view of the electronic device 1 in the fifth embodiment. In the fifth embodiment, the determination unit 221 determines whether the electronic device 1 is positioned outdoors or indoors based on whether or not the internal time is within a predetermined time range. Regarding the internal time, for example, the determination unit 221 acquires the value of the hour counter, the value of the minute counter, and the value of the second counter of the internal time measuring unit 243.

For example, time zone information based on the behavior pattern of the user of the electronic device 1 is stored in the storage 20. In the time zone information, for example, the range from the first time to the second time indicates that the electronic device 1 is positioned outdoors since the user is going to work or school and the range from the second time to the third time indicates that the electronic device 1 is positioned indoors since the user is at work or at school. In addition, the determination unit 221 refers to the time zone information, specifies the range that corresponds to the internal time, and determines whether the electronic device 1 is positioned outdoors or indoors in accordance with the specified range.

### E.2. Effect of Fifth Embodiment

As described above, based on the internal time, the determination unit 221 determines whether the electronic device 1 is positioned outdoors or indoors. When the behavior pattern of the user of the electronic device 1 is fixed, it becomes possible to determine whether the electronic device 1 is positioned outdoors or indoors with high accuracy.

### F. Sixth Embodiment

In the first to the fifth embodiments, it was determined whether the electronic device 1 was positioned indoors or outdoors. In a sixth embodiment, in a case where the speed of the electronic device 1 exceeds a predetermined threshold value, the control of the oscillation circuit 23 such that the frequency f_{VCO} of the clock signal is close to the reference frequency f0 is suppressed. Hereinafter, the sixth embodiment will be described. In addition, in each aspect and each modification example described below, elements having the same operations or functions as those in the first embodiment, the second embodiment, the third embodiment, the fourth embodiment, or the fifth embodiment, will be given the same reference numerals as those used in the first embodiment, the second embodiment, the third embodiment, the fourth embodiment, or the fifth embodiment, and the detailed description thereof will be appropriately omitted.

### F.1. Outline of Electronic Device 1 According to Sixth Embodiment

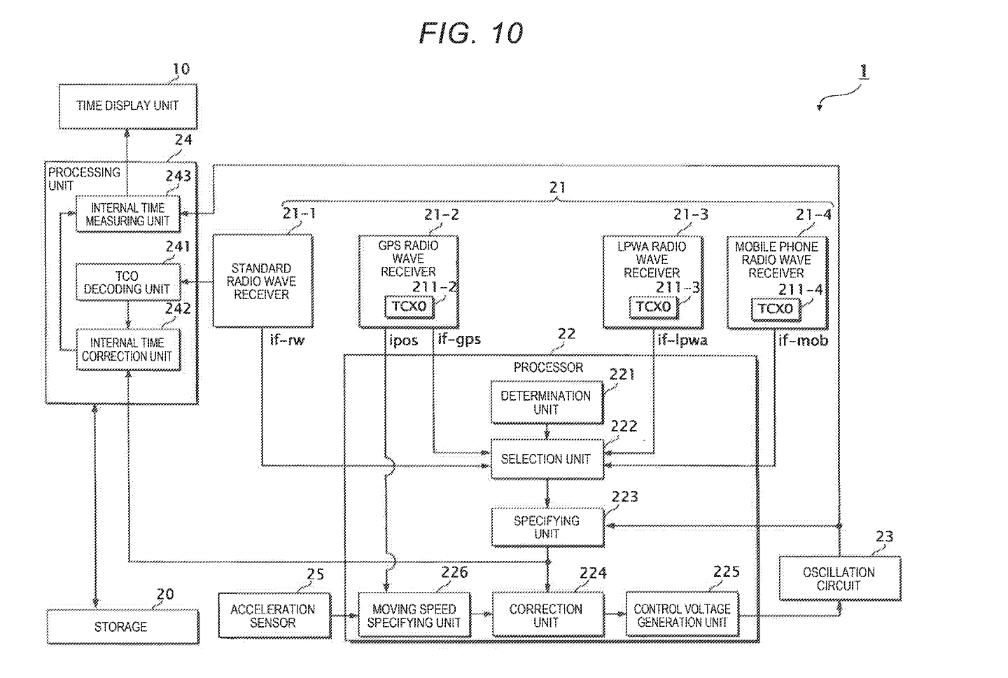

FIG. 10 illustrates a configuration view of the electronic device 1 in the sixth embodiment. In the sixth embodiment, the processor 22 includes a moving speed specifying unit 226. The determination unit 221 in the sixth embodiment determines whether the electronic device 1 is positioned indoors or outdoors by any of the methods of the first embodiment to the fifth embodiment.

The moving speed specifying unit 226 specifies the moving speed of the electronic device 1. The moving speed specifying unit 226 outputs the specified moving speed to the correction unit 224. There are three specifying methods of the moving speed, for example, as follows. In a first specifying method of the moving speed, the moving speed specifying unit 226 acquires the acceleration measured by the acceleration sensor 25, integrates the acquired acceleration once, and specifies the moving speed.

In a second specifying method of the moving speed, the moving speed specifying unit 226 acquires positional information ipos of the electronic device 1 based on the GPS wave from the GPS radio wave receiver 21-2 at a predetermined cycle. The moving speed specifying unit 226 specifies the moving speed of the electronic device 1 from the positional information ipos and the predetermined cycle.

In a third specifying method of the moving speed, the first specifying method of the moving speed and the second specifying method of the moving speed are combined with each other. For example, the moving speed specifying unit 226 corrects the positional information ipos with the moving distance obtained by integrating the acceleration twice. Then, the moving speed specifying unit 226 specifies the moving speed of the electronic device 1 from the positional information after the correction and the predetermined cycle. FIG. 10 illustrates the third specifying method of the moving speed.

In a case where the moving speed specified by the moving speed specifying unit 226 exceeds a predetermined threshold value, the correction unit 224 suppresses the control of the oscillation circuit 23 such that the frequency f_{VCO} of the clock signal is close to the reference frequency f0. For example, in a case where the moving speed specified by the moving speed specifying unit 226 exceeds a predetermined threshold value, the correction unit 224 sets the value of the control voltage constant before and after the moving speed exceeds the predetermined threshold value. In other words, in a case where the moving speed exceeds the predetermined threshold value, the correction unit 224 does not perform the correction. In general, when the electronic device 1 is moving at high speed, the frequency of the carrier wave of the radio wave changes due the Doppler effect, and thus, there is a case where an error occurs in the frequency of the carrier wave. The predetermined threshold value is, for example, a moving speed in a case where a maximum value in which the error included in the frequency of carrier wave of the radio wave is allowed is achieved.

### F.2. Effect of Sixth Embodiment

As described above, in a case where the moving speed of the electronic device 1 exceeds the predetermined threshold value, the correction unit 224 sets the value of the control voltage constant before and after the moving speed exceeds the predetermined threshold value. In general, in a case where the electronic device 1 is moving at a high speed, for example, in a case where the user of the electronic device 1 is in a moving train, there is a case where the frequency of the carrier wave of the radio wave changes due to the Doppler effect. When the frequency of the clock signal is corrected using the frequency of the carrier wave in which the error occurs, there is a concern that the accuracy of the internal time deteriorates. Therefore, in a case where the moving speed of the electronic device 1 exceeds the predetermined threshold value, the correction unit 224 can suppress the deterioration of the accuracy of the internal time by making the value of the control voltage constant before and after exceeding the predetermined threshold without using the frequency of the carrier wave of the received radio wave.

### G. Modification Example

Each of the above-described aspects can be variously modified. Specific aspects of modifications are exemplified below. Two or more aspects which are selected in any manner from the following examples can be appropriately combined with each other within a range of not being mutually contradictory. In addition, in the modification example exemplified below, the elements having the same operations or functions as those in the embodiments will be given the same reference numerals as those used in the above-described embodiments, and the detailed description thereof will be appropriately omitted.

In the first embodiment, it is described that the selection unit 222 selects the GPS frequency information if-gps in a case where the determination result of the determination unit 221 is outdoors, but the standard radio wave frequency information if-rw may be selected. For example, in a case where the determination result of the determination unit 221 is outdoors, the selection unit 222 may select the selected frequency information of radio wave having a higher reception intensity from the standard radio wave and the GPS radio wave.

In the third embodiment, the determination unit 221 determines whether the electronic device 1 is positioned outdoors or indoors by using the solar cell 15, but the invention is not limited thereto. For example, the electronic device 1 may include an illuminance sensor, and the determination unit 221 may determine whether the electronic device 1 is positioned outdoors or indoors based on the comparison result between a light amount measured by the illuminance sensor and a predetermined threshold value.

In each of the above-described aspects, the selection unit 222 outputs the selected frequency information from the standard radio wave frequency information if-rw, the GPS frequency information if-gps the LPWA frequency information if-lpwa, and the mobile phone frequency information if-mob, but the invention is not limited thereto. For example, the selection unit 222 may select the selected frequency information from, the two frequency information.

The determination unit 221 may combine any two or three methods from the first embodiment to the fifth embodiment. For example, in the third embodiment, is assumed that the predetermined threshold value is a value smaller than the power generation amount that can be generated by the solar cell 15 in a case where the weather is cloudy or rainy such that it is determined that the electronic device is outdoors even when the weather is cloudy or rainy. However, in a case where the predetermined threshold value is a small value, when the electronic device is in an extremely bright indoor area, there is a concern that the determination unit 221 determines that the power generation amount becomes greater than the predetermined threshold value and the electronic device is outdoors. Here, in combination with the fourth embodiment, the determination unit 221 determines that the electronic device 1 is positioned outdoors when the power generation amount is equal to or greater than the predetermined threshold value and the speed obtained by integrating the acceleration is equal to or greater than the predetermined threshold value.

Further, in the second determination method of determining whether the electron device is outdoors or indoors based on the acceleration in the fourth embodiment, when the speed obtained by integrating the acceleration measured by the acceleration sensor 25 is higher than the general walking speed, it is determined that the electronic device 1 is positioned outdoors. However, in a case where the speed obtained by integrating the acceleration measured by the acceleration sensor 25 is equal to or less than the general walking speed, there is a case of moving outdoors on foot or there is a case of moving indoors on foot, and thus, correct determination is not possible. Here, in the determination unit 221, in a case where the speed obtained by integrating the acceleration measured by the acceleration sensor 25 is equal to or lower than the general walking speed, the first determination method of determining whether the electronic device is outdoors or indoors based on the acceleration in the fourth embodiment, the third determination method, or any one of the methods of the second embodiment, the third embodiment, and the fifth embodiment may be combined with each other.

The determination unit 221 may combine all of the methods from the first embodiment to the fifth embodiment. Specifically, the determination unit 221 executes the determination methods of each of the first to fifth embodiments, sets the evaluation value of +1 in a case where it is determined that the electronic device is outdoors according to each of the determination methods, and sets the evaluation value of +0 in a case where the electronic device is indoors according to each of the methods. In addition, the determination unit 221 accumulates the evaluation values obtained by each of the methods, and determines that the electronic device is outdoors when a cumulative value is equal to or greater than the predetermined threshold value.

In each of the above-described aspects, the GPS radio wave receiver 21-2 receives the radio wave transmitted from the GPS satellite, but the electronic device 1 may receive the radio wave from a positioning satellite of a global navigation satellite system (GNSS) other than the GPS or a positioning satellite other than the GNSS. For example, the electronic device 1 may receive the radio wave from the satellite of one of or a combination of two or more of the satellite positioning systems, such as a wide area augmentation system (WARS), European geostationary-satellite navigation overlay service (EGNOS), quasi zenith satellite system (QZSS), global navigation satellite system (GLONASS), GALILEO, or BeiDou navigation satellite system (BeiDou).

In each of the above-described aspects, the mobile phone radio wave receiver 21-4 includes the TCXO 211-4, but the invention is not limited thereto. For example, the mobile phone radio wave receiver 21-4 may include a VCO instead of the TCXO 211-4. In this case, the mobile phone radio wave receiver 21-4 adjusts the frequency of the clock signal oscillated by the VCO to the frequency of the carrier wave of the received mobile phone radio wave. In order to adjust the frequency of the VCO, the accuracy of the frequency of the clock signal output from the VCO becomes equivalent to the accuracy of the frequency of the carrier wave of the mobile phone radio wave. Therefore, in a case where the mobile phone radio wave receiver 21-4 includes the VCO, it is possible to carry out each of the above-described aspects even when the mobile phone radio wave receiver 21-4 does not output the carrier frequency difference Δf-mob.

In each of the above-described aspects, the first receiver and the second receiver have received the radio wave, but the target to be received is not limited to the radio wave but may be light. For example, the electronic device 1 may have the illuminance sensor, generate an AC signal that corresponds to the flashing of the illumination by an AC current, and convert the generated AC signal into the reference wave. The illumination is, for example, a fluorescent lamp or a light emitting diode (LED). The accuracy of the frequency of the AC current is ±0.1 Hz at 60 Hz, and has a monthly difference of ±1 second (1.67 ppm).

In each of the above-described aspects, it is assumed that the frequency f_{VCO} of the clock signal is always corrected in a case where the receiver 21 receives the radio wave, but the invention is not limited thereto. For example, even when the receiver 21 receives the radio wave, the frequency f_{VCO} of the clock signal may not be corrected every time but may be intermittently corrected, for example, once every several times. Even with such a configuration, it becomes possible to improve the accuracy of the internal time compared to a case where the frequency f_{VCO} of the clock signal is not corrected at all.

In each of the above-described aspects, the standard radio wave is JJY and the frequency of the carrier wave of JJY is set to 40 kHz, but the invention is not limited thereto. Each of the above-described aspects can be applied even when the frequency of the carrier wave of JJY is 60 kHz, and even when the standard radio wave is WWVB, DCF77, MSF, BPC, or the like, the aspects can be applied.

In each of the above-described aspects, the signal included in the selected frequency information is converted into the reference wave, but the clock signal may be converted into the frequency indicated by the selected frequency information. However, since the exact frequency of the clock signal s unknown, the electronic device 1 may multiply the frequency of the clock signal (frequency indicated by selected frequency information/reference frequency f0) times by using the NCO, and may specify the frequency difference Δfv. Otherwise, in each of the above-described aspects, the carrier wave and the clock signal of the selected frequency information may be converted into frequencies different from the frequencies indicated by the reference frequency f0 and the selected frequency information, respectively, and the frequency difference Δfv may be specified.

In each of the above-described aspects, the GPS frequency information if-gps includes the clock signal f-gps and the carrier frequency difference Δf-gps, but the invention is not limited thereto. For example, the GPS radio wave receiver 21-2 may have the NCO, and convert the frequency of the clock signal f-gps into the frequency of the carrier wave of the GPS radio wave, and the GPS frequency information if-gps may include only the clock signal after the conversion. The LPWA frequency information if-lpwa and the mobile phone frequency information if-mob are also similar.

In each of the above-described aspects, the correction unit 224 outputs the data indicating the voltage such that the frequency difference Δfv is canceled to the control voltage generation unit 225, but the invention is not limited thereto. In general, due to the adherence and removal of dust to and from the crystal oscillator occurring in an air-tightly sealed container of the oscillation circuit 23, the environmental change due to some outgas, the change over the years of an adhesive used in the oscillation circuit 23, or the like, the frequency of the clock signal generated in a case where a predetermined control voltage is input to the oscillation circuit changes. Here, the electronic device 1 may have cumulative operation time characteristic information related to the cumulative operation time of the oscillation circuit 23 and the frequency of the clock signal generated in a case where the predetermined control voltage is input to the oscillation circuit 23, and the correction unit 224 may correct the frequency of the clock signal of the oscillation circuit 23 by updating the cumulative operation time characteristic information such that the frequency difference Δfv is canceled. The characteristic indicated by the cumulative operation time characteristic information is a so-called aging characteristic. Alternatively, the electronic device 1 may have temperature characteristic information related to the temperature that can be obtained by the oscillation circuit 23 and the frequency of the clock signal generated in a case where the predetermined voltage is input to the oscillation circuit 23, and the correction unit 224 may update the temperature characteristic information such that the frequency difference ΔFv is canceled and correct the frequency of the clock signal of the oscillation circuit 23.

In the sixth embodiment, in a case where the moving speed specified by the moving speed specifying unit 226 exceeds the predetermined threshold value, as a method of suppressing the control of the oscillation circuit 23 such that the frequency f_{VCO} of the clock signal is close to the reference frequency f0, the method of making the value of the control voltage constant before and after the moving speed exceeds the predetermined threshold value is described as an example, but the invention is not limited thereto. For example, s assumed that electronic device 1 stores the above-described temperature characteristic information, Based on the assumption, in a case where the moving speed specified by the moving speed specifying unit 226 exceeds the predetermined threshold value, the correction unit 224 may perform not only the correction of the frequency of the clock signal of the oscillation circuit 23 by updating the temperature characteristic information based on the frequency difference Δfv, but also the correction of the frequency of clock signal of oscillation circuit 23 based on the temperature characteristic information which has not been updated. Accordingly, in a case where the electronic device 1 is moving at a high speed and there is a large temperature change, since the electronic device 1 can control the oscillation circuit 23 in accordance with the temperature change even during the high-speed movement, it becomes possible to improve the accuracy of the internal time.

In each of the above-described aspects, the internal time correction unit 242 sets the internal time based on the time code obtained from the TCO decoding unit 241, but the internal time correction unit 242 may set the internal time based on the time information included in the baseband signal obtained by demodulating the GPS radio wave. For example, the internal time may be set by using a pulse per second (PPS) signal output from the GPS radio wave receiver 21-2. The PPS signal is output once every 1 second of the accurate time specified from the time information included in the GPS radio wave. The internal time correction unit 242 sets the internal time based on the time information included in the baseband signal obtained by demodulating the GPS radio wave considering the reception of the PPS signal output from the GPS radio wave receiver 21-2 as a trigger. Similarly, in a case where the time information is included in the baseband signal obtained by demodulating the LPWA radio wave, the internal time correction unit 242 may set the internal time based on the time information. Further, in a case where the user gets down to the airport, terminal station, and the like, the LPWA radio wave receiver 21-3 may receive the LPWA radio wave, acquire the baseband signal, and set the time zone.

In each of the above-described aspects, the internal time correction unit 242 may correct the internal time based on the frequency difference Δfv and the number of clock signals from the time when the internal time is set based on the GPS radio wave or the LPWA radio wave to the current time.

Accordingly, it becomes possible to complete the correction of the internal time in a shorter period of time the time information included in the GPS radio wave or the LPWA radio wave always in a case where the GPS electric wave or the LPWA electric wave is received. In order to obtain the time information from the GPS radio wave or the LPWA radio wave, it is necessary to demodulate the GPS radio wave or the LPWA radio wave, but in a case where the internal time is corrected by using the frequency indicated by the frequency information, the GPS radio wave may not be demodulated. Therefore, by correcting the internal time by using the phase difference between the reference frequency f0 and the frequency of the clock signal, compared to a case where the internal time is corrected by always using the time information from the GPS radio wave or the LPWA radio wave, it becomes possible to reduce the load on the correction of the internal time.

In each of the above-described aspects, the correction of the internal time may be performed based on the first selected frequency information selected from the standard radio wave frequency information if-rw, the GPS frequency information if-gps, the LPWA frequency information if-lpwa, or the mobile phone frequency information if-mob, and the frequency of the clock signal of the oscillation circuit 23 may be corrected by using the second selected frequency information different from the first selected frequency information.

In each of the above-described aspects, the electronic device 1 is not limited to the wristwatch illustrated in FIG. 1, but may be a clock or an electronic timepiece, such as a wall clock. Furthermore, the electronic device 1 is not limited to the electronic timepiece, and any device may be used as long as the device is a device that measures the time. For example, the electronic device 1 may be a display device, such as a television, a monitor electronic paper, or a car navigation device, an imaging device, such as a video camera, or an information processing terminal, such as a mobile phone, a smartphone, or a game machine. Furthermore, the display method of the electronic device 1 is not limited to an analog type illustrated in FIG. 1, but may be a digital type. In a case where the display method of the electronic device 1 is the digital type, the electronic device 1 may display an image indicating that the correction is completed when the clock frequency is corrected.

In each of the above-described aspects, the electronic device can also be regarded as a computer program configured to cause the processor 22 to function or a computer readable recording medium in which the computer program is recorded. The recording medium is, for example, a non-transitory recording medium and may include any known recording medium, such as a semiconductor recording medium or a magnetic recording medium, in addition to an optical recording medium, such as a CD-ROM. Further, the invention also specified as a control method of the electronic device according to each of the above-described aspects.

In each of the above-described aspects, in processor 22, all or a part of the elements realized by executing the program may be realized by hardware by an electronic circuit, such as an FPGA or an ASIC, or may be realized by the cooperation of software and hardware. The processor 22 may be one electronic circuit or may be a plurality of electronic circuits. Although it is described that the internal time correction unit 242 is realized by executing the program by the processing unit 24, the internal time correction unit 242 may be included in the processor 22.

What is claimed is:

1. An electronic device comprising:
a first receiver that receives a first radio wave and outputs first frequency information based on a carrier frequency of the first radio wave;
a second receiver that receives a second radio wave and outputs second frequency information based on a carrier frequency of the second radio wave;
an oscillation circuit that generates a clock signal used for measuring an internal time; and
a processor connected to the first receiver, the second receiver, and the oscillation circuit, the processor being configured to:
determine a reception environment, of the first radio wave and the second radio wave; and
control the oscillation circuit such that the frequency of the clock signal is close to a reference frequency determined based on any of the first frequency information and the second frequency information, based on a determination result of the reception environment.

2. The electronic device according to claim 1,
wherein the first radio wave is a standard radio wave or a radio wave transmitted from a positional information satellite, and
the processor is further configured to:
determine whether the reception environment is indoors or outdoors;
select the first frequency information in a case where the determination result of the reception environment is outdoors; and
select the second frequency information in a case where the determination result of the reception environment is indoors.

3. The electronic device according to claim 2, wherein the processor determines whether the reception environment is indoors or outdoors based on a reception intensity of the first radio wave received by the first receiver and a reception intensity of the second radio wave received by the second receiver.

4. The electronic device according to claim 1, further comprising:
a solar cell connected to the processor,
wherein the processor determines whether the reception environment is indoors or outdoors based on a comparison result between a power generation amount per unit time generated by the solar cell and a predetermined threshold value.

5. The electronic device according to claim 1, further comprising:
an acceleration sensor connected to the processor,
wherein the processor determines whether the reception environment is indoors or outdoors based on a signal from the acceleration sensor.

6. The electronic device according to claim 1, wherein the processor determines whether the reception environment is indoors or outdoors based on whether or not the internal time is within a predetermined time range.

7. The electronic device according to claim 1, wherein the processor is further configured to:
output a control voltage for controlling the oscillation circuit;
specify a moving speed of the electronic device by using the first radio wave; and
suppress a control of the oscillation circuit such that the frequency of the clock signal is close to the reference frequency in a case where the moving speed exceeds a predetermined threshold value.

8. The electronic device according to claim 1, wherein the second radio wave is a radio wave from a base station included in a mobile phone network.

9. The electronic device according to claim 1, wherein the processors is further configured to:
specify a difference between the reference frequency and the frequency of the clock signal; and
control the oscillation circuit and correct the frequency of the clock signal so as to be close to the reference frequency, based on the difference.

10. The electronic device according to claim 9, wherein the processor is further configured to:
perform numerical arithmetic processing of converting a frequency with respect to the first frequency information or the second frequency information selected based on the determination result of the reception environment;
generate a reference wave having the reference frequency; and
specify the difference between the reference frequency and the frequency of the clock signal based on a first phase difference between the reference wave and the clock signal at a first time, a second phase difference between a reference wave and a clock signal at a second time, and a time period from the first time to the second time.

11. The electronic device according to claim 2, wherein the processor is further configured to:
specify a difference between the reference frequency and the frequency of the clock signal; and
control the oscillation circuit and correct the frequency of the clock signal so as to be close to the reference frequency, based on the difference.

12. The electronic device according to claim 1,
wherein the first radio wave and the second radio wave are each any of a radio wave transmitted from a positional information satellite, a standard radio wave, and a radio wave from a base station included in a mobile phone network, and
the processor is further configured to:
correct the internal time based on a number of the clock signals from a time when the internal time is set based on the first or second radio wave to a current time, and a difference between the reference frequency and the frequency of the clock signal.

13. A control method of an electronic device including a first receiver that receives a first radio wave and outputs first frequency information based on a carrier frequency of the first radio wave, a second receiver that receives a second radio wave and outputs second frequency information based on a carrier frequency of the second radio wave, and an oscillation circuit that generates a clock signal used for measuring an internal time, the method comprising:
determining, using the electronic device, a reception environment of the first radio wave and the second radio wave;
outputting, using the electronic device, any of the first frequency information and the second frequency information as selected frequency information based on a determination result of determining the reception environment; and
controlling, using the electronic device, the oscillation circuit such that the frequency of the clock signal is close to a reference frequency determined in accordance with the selected frequency information.

14. The control method according to claim 13,
wherein the first radio wave is a radio wave transmitted from a positional information satellite or a standard radio wave, and
the method further comprises:
determining, using the electronic device, whether the electronic device is positioned indoors or outdoors;
selecting, using the electronic device, the first frequency information in a case where the determination result as to whether the electronic device is positioned indoors or outdoors is outdoors; and
selecting, using the electronic device, the second frequency information in a case where the determination result is indoors.

15. The control method according to claim 14, further comprising:
determining, using the electronic device, whether the electronic device is positioned indoors or outdoors based on a reception intensity of the first radio wave received by the first receiver and a reception intensity of the second radio wave received by the second receiver.

16. The control method according to claim 13, further comprising:
determining, using the electronic device, whether the electronic device is positioned indoors or outdoors based on whether or not the internal time is within a predetermined time range.

17. The control method according to claim 13, further comprising:
outputting, using the electronic device, a control voltage for controlling the oscillation circuit;
specifying, using the electronic device, a moving speed of the electronic device; and
suppressing, using the electronic device, a control of the oscillation circuit such that the frequency of the clock signal is close to the reference frequency in a case where the specified moving speed exceeds a predetermined threshold value.

18. The control method according to claim 13, wherein the second radio wave is a radio wave from a base station included in a mobile phone network.

19. The control method according to claim 13, further comprising:
specifying, using the electronic device, a difference between the reference frequency and the frequency of the clock signal; and
controlling, using the electronic device, the oscillation circuit and correcting the frequency of the clock signal so as to be close to the reference frequency, based on the difference.

20. The control method according to claim 19,
wherein the selected frequency information includes a signal of a carrier frequency of the received radio wave,
and the method further comprises:
performing a numerical arithmetic operation for converting the frequency with respect to the signal included in the selected frequency information and converting the signal into a reference wave of the reference frequency; and
specifying a difference based on a first phase difference between the reference wave and the clock signal at a first time, a second phase difference between the reference wave and the clock signal at a second time, and a time period from the first time to the second time.

21. An electronic device comprising:
a global positioning system (GPS) receiver that receives a GPS radio wave and outputs first frequency information based on a carrier frequency of the GPS radio wave;
a second receiver that receives a second radio wave other than the GPS radio wave and outputs second frequency information based on a carrier frequency of the second radio wave;
an oscillation circuit that generates a clock signal used for measuring an internal time; and
a processor connected to the GPS receiver, the second receiver, and the oscillation circuit, the processor being configured to:
determine whether the electronic device is indoors or outdoors based on the GPS radio wave;
when the electronic device is outdoors, set a reference frequency based on the first frequency information;
when the electronic device is indoors, set the reference frequency based on the second frequency information; and
control the oscillation circuit such that the frequency of the clock signal is close to the reference frequency; and
a display connected to the processor that displays a time based on the internal time.
